(19) United States
(12) Patent Application Publication
(10) Pub. No.: US 2022/0186060 A1
(43) Pub. Date: Jun. 16, 2022

(54) FLUID SET

(71) Applicant: Hewlett-Packard Development Company, L.P., Spring, TX (US)

(72) Inventors: Dennis Z. Guo, San Diego, CA (US); Jie Zheng, San Diego, CA (US)

(21) Appl. No.: 17/433,180

(22) PCT Filed: Jul. 12, 2019
(86) PCT No.: PCT/US2019/041669

§ 371 Date: Aug. 23, 2021

(51) Int. Cl. C09D 11/40; C09D 11/54; C09D 11/322; C09D 11/023; C09D 11/12; C09D 11/107; D06P 5/30; D06P 5/00; D06P 1/44; D06P 1/52; B41M 5/00; B41M 7/00

(52) U.S. Cl. CPC C09D 11/40; B41M 7/009; C09D 11/322; C09D 11/023; C09D 11/12; C09D 11/107; D06P 5/30; D06P 5/002; D06P 5/001; D06P 1/445; D06P 1/525; B41M 5/0023; B41M 5/0017; B41M 5/0047; C09D 11/54

(57) ABSTRACT

A fluid set includes a pre-treatment composition, a fixer composition, and an inkjet ink. The pre-treatment composition includes a wax emulsion or a fluorinated polymer emulsion. The fixer composition includes a cationic polymer and a fixer vehicle. The inkjet ink includes a white pigment, a polymeric binder, and an ink vehicle.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing, e.g., for creating signs, banners, artwork, apparel, wall coverings, window coverings, upholstery, pillows, blankets, flags, tote bags, clothing, etc. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 schematically illustrates an example fluid set and an example textile printing kit, each of which includes an example of a pre-treatment composition, an example of a fixer composition, and an example of an inkjet ink;

FIG. 2 is a flow diagram illustrating an example printing method;

FIG. 3 is a schematic diagram of an example of a printing system;

FIGS. 4A through 4D are optical microscope images of example prints generated with examples of the pre-treatment composition (including different wax emulsions), the fixer composition, and the inkjet ink disclosed herein;

FIGS. 5A through 5D are optical microscope images of comparative example prints generated with no pre-treatment fluid or water as a pre-treatment fluid; and

FIGS. 6A through 6C are optical microscope images of example prints generated with examples of the pre-treatment composition (including different fluorinated polymer emulsions), the fixer composition, and the inkjet ink disclosed herein.

### DETAILED DESCRIPTION

The textile market is a major industry, and printing on textiles, such as cotton, etc., has been evolving to include digital printing methods. Some digital printing methods enable direct to garment (or other textile) printing. White ink is one of the most heavily used inks in direct to textile printing. More than two-thirds of the textile printing that is performed utilizes a white ink on a colored textile. Obtaining white images with desirable opacity has proven to be challenging, in part because of fibrillation (e.g., hair-like fibers sticking out of the fabric surface). To control fibrillation and to achieve a suitable opacity of a white image on a colored garment, several techniques have been explored. As one example, a high level (e.g., from about 240 grams per square meter (gsm) to about 320 gsm) of a pre-treatment composition may be applied onto the garment before the white ink is deposited. As another example, multiple layers of the ink may be deposited in the same spot. Both of these techniques involve applying high levels of fluid, which increases printing cost and drying and/or curing time. As yet another example, the garment may be pretreated with water (e.g., >150 gsm) and then squeegeed to remove excess water. This technique mats down the hair-like fibers (and thus reduces fibrillation) and also saturates pores of the garment to slow subsequent ink penetration, which leads to improved opacity compared to a garment not exposed to this technique. However, the excess water has to be removed prior to or during curing, and thus this technique involves additional drying time and/or heating power.

Disclosed herein is a fluid set that is particularly suitable for obtaining white images with desirable opacity, durability (i.e., washfastness), and, in some instances, oil resistance. The fluid set includes a pre-treatment composition, a fixer composition, and an inkjet ink. The pre-treatment composition includes a wax emulsion or a fluorinated polymer emulsion, each of which decreases fibrillation by forming a film on the fibers of the textile and/or in the pores between the fibers of the textile. This film is more hydrophobic than the textile alone, and thus subsequently deposited ink is not able to penetrate into the textile rapidly. This enables the fixer composition (which is applied on the film prior to the inkjet ink) more time to react with the inkjet ink, which in turn enables the pigment to become fixed at the surface of the textile. As such, the combination of the pre-treatment composition, the fixer composition, and the inkjet ink improves the opacity and image quality of white images printed on colored textiles.

It has been found that relatively small amounts of the pre-treatment composition (e.g., less than 100 gsm) may be used to achieve the white images, and thus the amount of energy and time involved in drying and/or curing is reduced.

As mentioned, the fluid set disclosed herein leads to improved opacity and durability.

The opacity may be measured in terms of L*, i.e., lightness, of the white print generated with the fluid set disclosed herein on a colored textile fabric. A greater L* value indicates a greater opacity of the white ink on the colored textile fabric. L* is measured in the CIELAB color space, and may be measured using any suitable color measurement instrument (such as those available from HunterLab or X-Rite). The inkjet ink, when printed on the colored textile fabric pretreated with the pre-treatment composition and the fixer composition disclosed herein, may generate prints that have an L* value that is greater than prints generated on the same colored textile fabric with the same inkjet and one of: i) without the pre-treatment composition and without pre-heating, ii) without the pre-treatment composition but with pre-heating, iii) with water and pre-heating as the pre-treatment technique, or iv) with water and squeegeeing as the pre-treatment technique.

The durability of a print on a fabric may be assessed by its ability to retain color after being exposed to washing. This is also known as washfastness. Washfastness can be measured in terms of ΔE. The term “ΔE,” as used herein, refers to the change in the L*a*b* values of a color (e.g., cyan, magenta, yellow, black, red, green, blue, white) after washing. ΔE can be calculated by different equations, such as the ΔE_{CIE} formula (given in the example section below), the CIEDE1976 color-difference formula, and the CIEDE2000 color-difference formula. ΔE can also be calculated using the color difference method of the Color Measurement Committee (ΔE_{CMC}).

The compositions and/or inkjet ink disclosed herein may include different components with different acid numbers. As used herein, the term “acid number” refers to the mass of potassium hydroxide (KOH) in milligrams that is used to neutralize one (1) gram of a particular substance. The test for determining the acid number of a particular substance may vary, depending on the substance. For example, to determine the acid number of a polyurethane-based binder, a known amount of a sample of the binder may be dispersed in water and the aqueous dispersion may be titrated with a polyelectrolyte titrant of a known concentration. In this example, a current detector for colloidal charge measurement may be used. An example of a current detector is the MUtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used

Throughout this disclosure, a weight percentage that is referred to as “wt % active” refers to the loading of an active component of a dispersion or other formulation that is present in the inkjet ink or the pre-treatment composition. For example, the white pigment may be present in a water-based formulation (e.g., a stock solution or dispersion) before being incorporated into the inkjet ink. In this example, the wt % actives of the white pigment accounts for the loading (as a weight percent) of the white pigment that is present in the inkjet ink, and does not account for the weight of the other components (e.g., water, etc.) that are present in the formulation with the white pigment. The term “wt %,” without the term actives, refers to either i) the loading (in the inkjet ink or the pre-treatment composition) of a 100% active component that does not include other non-active components therein, or the loading (in the inkjet ink or the pre-treatment composition) of a material or component that is used “as is” and thus the wt % accounts for both active and non-active components.

### Sets and Kits

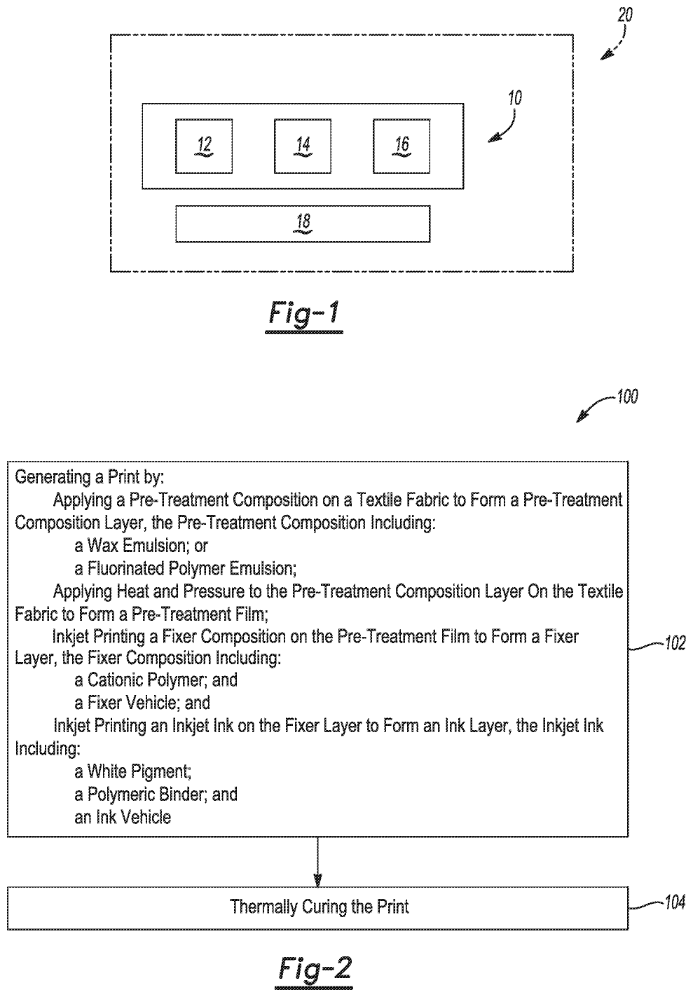

An example of the fluid set disclosed herein is shown schematically in FIG. 1. As depicted, the fluid set 10 comprises a pre-treatment composition 12 including a wax emulsion or a fluorinated polymer emulsion; a fixer composition 14 including a cationic polymer and a fixer vehicle; and an inkjet ink 16 including a white pigment, a polymeric binder, and an ink vehicle.

It is to be understood that any example of the pre-treatment composition 12, the fixer composition 14, and the inkjet ink 16 disclosed herein may be used in the examples of the fluid set 10.

In one example, the fluid set 10 includes a pre-treatment composition 12 that is formulated for analog application (e.g., spraying), and a fixer composition 14 and an inkjet ink 16 that are formulated for thermal inkjet printing. In another example, the fluid set 10 includes a pre-treatment composition 12, a fixer composition 14, and an inkjet ink that are formulated for thermal inkjet printing. In still another example, the fluid set 10 includes a pre-treatment composition 12, a fixer composition 14, and an inkjet ink that are formulated for piezoelectric inkjet printing.

In any example of the fluid set 10, the pre-treatment composition 12, the fixer composition 14, and the inkjet ink 16 may be maintained in separate containers (e.g., respective reservoirs/fluid supplies of respective inkjet cartridges) or separate compartments (e.g., respective reservoirs/fluid supplies) in a single container (e.g., inkjet cartridge).

The fluid set 10 may also be part of a textile printing kit 20, which is also shown schematically in FIG. 1. In an example, the textile printing kit 20 includes a textile fabric 18; and the fluid set 10, which includes the pre-treatment composition 12 including a wax emulsion or a fluorinated polymer emulsion; a fixer composition 14 including a cationic polymer and a fixer vehicle; and an inkjet ink 16 including a white pigment, a polymeric binder, and an ink vehicle.

It is to be understood that any example of the pre-treatment composition 12, the fixer composition 14, and the inkjet ink 16 disclosed herein may be used in the examples of the textile printing kit 20. It is also to be understood that any example of the textile fabric 18 may be used in the examples of the textile printing kit 20.

### Pre-Treatment Composition

The pre-treatment composition 12 includes a wax emulsion or a fluorinated polymer emulsion. A wax emulsion is a stable mixture of one or more waxes in water. Similarly, a fluorinated polymer emulsion is a stable mixture of one or more fluorinated polymers in water. The wax emulsion and fluorinated polymer emulsion may also be referred to, respectively, as a wax dispersion and a fluorinated polymer dispersion because some waxes and fluorinated polymers are solids at room temperature. An emulsion process is used to emulsify the wax or fluorinated polymer, and this process involves a surfactant and heating above the melting point of the wax or of the fluorinated polymer. This process results in the formation water compatible wax or fluorinated polymer emulsions.

### Wax Emulsion

Examples of the pre-treatment composition 12 including the wax emulsion include water, wax, and a surfactant. In some instances, the pre-treatment composition 12 consists of these components, without any other components. In other instances, the pre-treatment composition 12 incudes the wax emulsion, a polymeric binder, and a vehicle, which includes additional water and an antimicrobial agent. In some examples, water alone is used as the vehicle for the pre-treatment composition 12. In other example examples, co-solvent(s) and/or additional surfactant(s) may be included in the pre-treatment vehicle in addition to water.

In an example where the pre-treatment composition 12 includes the wax emulsion, the wax in the wax emulsion has a glass transition temperature less than 150° C. In another example where the pre-treatment composition 12 includes the wax emulsion, the wax in the wax emulsion has a glass transition temperature ranging from 35° C. to less than 150° C. In an example, the wax emulsion is selected from the group consisting of a paraffin wax emulsion, a polyethylene wax emulsion, an oxidized polyethylene wax emulsion, a carnauba wax emulsion, a beeswax emulsion, and a combination thereof. As an example, an alkane paraffin wax may have the structure (I):

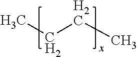

where x=12-18. As another example, the polyethylene wax may have the structure (II):

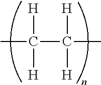

wherein n is selected so that the number average molecule weight ranges from about 500 g/mol to about 10,000 g/mol.

The wax in the wax emulsion has a particle size ranging from about 100 nm to about 5 μm. This particle size may be a volume-weighted mean diameter.

The wax emulsion in the pre-treatment composition 12 may be purchased commercially or may be prepared from suitable materials.

Some examples of suitable commercially available wax emulsions include SEQUAPEL® 414 and SEQUAPEL® 417 (anionic paraffin wax emulsions, from Omnova Solutions), those in the LIQUILUBE™ series from Lubrizol Corporation (e.g., LIQUILUBE™ 405 (non-ionic polyethylene emulsion), LIQUILUBE™ 418 (anionic paraffin-polyethylene emulsion), LIQUILUBE™ 454 (non-ionic paraffin emulsion), LIQUILUBE™ 458 (anionic high density, oxidized polyethylene emulsion), etc.), and those in the AQUACER® series from BYK Additives and Instruments (e.g., AQUACER® 494 (anionic paraffin wax emulsion), AQUACER® 497 (non-ionic paraffin wax emulsion), etc.).

To prepare the wax emulsion, the solid wax is melted in the presence of a surfactant, and water is added while the mixture is stirred. Any anionic, cationic, or non-ionic surfactant may be used in the preparation of the wax emulsion, although fatty alcohol ethoxylates may be desirable.

The non-volatile solids content of the as received or the as prepared wax emulsion may range from about 15% to about 60% of the total weight of the wax emulsion. In one example, the non-volatile solids content of the as received or the as prepared wax emulsion may range from about 25% to about 60% of the total weight of the wax emulsion.

In examples where the pre-treatment composition 12 includes the wax emulsion, the wax emulsion is present in an amount ranging from about 1 wt % to about 40 wt % based on a total weight of the pre-treatment composition 12.

### Fluorinated Polymer Emulsion

Examples of the pre-treatment composition 12 including the fluorinated polymer emulsion include water, a fluorinated polymer, and a surfactant. In some instances, the pre-treatment composition 12 consists of these components, without any other components. In other instances, the pre-treatment composition 12 incudes the fluorinated polymer emulsion, a polymeric binder, and a vehicle, which includes additional water and an antimicrobial agent. In some examples, water alone is used as the vehicle for the pre-treatment composition 12. In other example examples, co-solvent(s) and/or additional surfactant(s) may be included in the pre-treatment vehicle in addition to water.

In an example where the pre-treatment composition 12 includes the fluorinated polymer emulsion, the fluorinated polymer in the fluorinated polymer emulsion is a perfluoroacrylated polymer. A perfluoroacrylate monomer unit includes an acrylate group and a fluorocarbon chain attached by an alkyl chain. In an example, the perfluoroacrylated polymer includes three perfluoroacrylate monomer units, and has the structure (III):

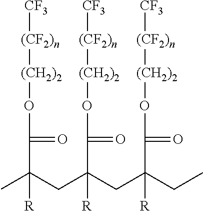

wherein R is either a hydrogen or a methyl radical; and n ranges from 1 to 11. In one example, n is 5. In another example, n is 7. In other examples, n may range from 1 to 11. Other examples of the perfluoroacrylated polymer include from 3 to 20 perfluoroacrylate monomer units. In still other examples, the perfluoroacrylated monomer may be polymerized so that the resulting polymer forms particles having a particle size ranging from about 50 nm to about 5 μm. This particle size may be a volume-weighted mean diameter.

The perfluoroacrylated polymers have been found to be particularly suitable for increasing the oil resistance of the textile fabrics. As such, the pre-treatment compositions 12 disclosed herein including the perfluoroacrylated polymer emulsion may be particularly desirable for applications oil stains are likely (e.g., with children, in hospitals, in automotive applications, etc.).

In another example where the pre-treatment composition 12 includes the fluorinated polymer emulsion, the fluorinated polymer in the fluorinated polymer emulsion is polytetrafluoroethylene.

The fluorinated polymer in the fluorinated polymer emulsion has a particle size ranging from about 30 nm to about 1 μm. This particle size may be a volume-weighted mean diameter.

The fluorinated polymer emulsion in the pre-treatment composition 12 may be purchased commercially or may be prepared from suitable materials.

Some examples of suitable commercially available fluorinated polymer emulsions include X-CAPE™ 2014 (cationic perfluoroacrylate polymer emulsion, from Omnova Solutions), PHOBOL® CP-C (a short chain (n=5 in structure III), cationic fluorinated acrylic polymer emulsion, from Huntsman Int.), and DYNEON™ PTFE TF 5060 GZ (non-ionic polytetrafluoroethylene dispersion, from 3M).

To prepare the fluorinated polymer emulsion, the solid fluorinated polymer is melted in the presence of a surfactant, and water is added while the mixture is stirred.

The non-volatile solids content of the as received or the as prepared fluorinated polymer emulsion may range from about 5% to about 50% of the total weight of the fluorinated polymer emulsion. In one example, the non-volatile solids content of the as received or the as prepared fluorinated polymer emulsion may range from about 25% to about 50% of the total weight of the fluorinated polymer emulsion.

In examples where the pre-treatment composition 12 includes the fluorinated polymer emulsion, the fluorinated polymer emulsion is present in an amount ranging from about 0.5 wt % to about 20 wt % based on a total weight of the pre-treatment composition 12.

### Polymeric Binder

As mentioned above, in some examples, the pre-treatment composition 12 includes a polymeric binder. Examples of the polymeric binder may include anionic, cationic, and/or non-ionic polymeric binders. The polymeric binder selected may depend, in part, on the ionic state of the wax emulsion or the fluorinated polymer emulsion that is used. For example, when an anionic wax emulsion or an anionic fluorinated polymer emulsion is used, anionic and/or non-ionic polymeric binders may be used. As another example, when a cationic wax emulsion or a cationic fluorinated polymer emulsion is used, cationic and/or non-ionic polymeric binders may be used. As still another example, when a non-ionic wax emulsion or a non-ionic fluorinated polymer emulsion is used, anionic, cationic, and/or non-ionic polymeric binders may be used.

Examples of the polymeric binder may be one of: a polyurethane-based binder selected from the group consisting of a polyester-polyurethane binder, a polyether-polyurethane binder, and a polycarbonate-polyurethane binder; or an acrylic latex binder.

In an example, the pre-treatment composition 12 includes the polyester-polyurethane binder. In an example, the polyester-polyurethane binder is an anionic sulfonated polyester-polyurethane binder. The sulfonated polyester-polyurethane binder can include diaminesulfonate groups. In an example, the polymeric binder is the polyester-polyurethane binder, the polyester-polyurethane binder is a sulfonated polyester-polyurethane binder, and is one of: i) an aliphatic compound including multiple saturated carbon chain portions ranging from C₄ to C₁₀ in length, and that is devoid of an aromatic moiety, or ii) an aromatic compound including an aromatic moiety and multiple saturated carbon chain portions ranging from C₄ to C₁₀ in length.

As mentioned, the sulfonated polyester-polyurethane binder can be anionic. In further detail, the sulfonated polyester-polyurethane binder can also be aliphatic, including saturated carbon chains as part of the polymer backbone or as a side-chain thereof, e.g., C₂ to C₁₀, C₃ to C₈, or C₃ to C₆ alkyl. These polyester-polyurethane binders can be described as “alkyl” or “aliphatic” because these carbon chains are saturated and because they are devoid of aromatic moieties. An example of an anionic aliphatic polyester-polyurethane binder that can be used is IMPRANIL® DLN-SD (Mw 133,000; Acid Number 5.2; Tg −47° C.; Melting Point 175-200° C.) from Covestro. Example components used to prepare the IMPRANIL® DLN-SD or other similar anionic aliphatic polyester-polyurethane binders can include pentyl glycols (e.g., neopentyl glycol); C₄ to C₁₀ alkyldiol (e.g., hexane-1,6-diol); C₄ to C₁₀ alkyl dicarboxylic acids (e.g., adipic acid); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Alternatively, the sulfonated polyester-polyurethane binder can be aromatic (or include an aromatic moiety) and can include aliphatic chains. An example of an anionic aromatic polyester-polyurethane binder that can be used is DISPERCOLL® U42. Example components used to prepare the DISPERCOLL® U42 or other similar aromatic polyester-polyurethane binders can include aromatic dicarboxylic acids, e.g., phthalic acid; C₄ to C₁₀ alkyl dialcohols (e.g., hexane-1,6-diol); C₄ to C₁₀ alkyl diisocyanates (e.g., hexamethylene diisocyanate (HDI)); diamine sulfonic acids (e.g., 2-[(2-aminoethyl)amino]ethanesulfonic acid); etc.

Other types of anionic polyester-polyurethanes can also be used, including IMPRANIL® DL 1380, which can be somewhat more difficult to jet from thermal inkjet printheads compared to IMPRANIL® DLN-SD and DISPERCOLL® U42, but still can be acceptably jetted in some examples, and can also provide acceptable washfastness results on a variety of fabric types.

The polyester-polyurethane binders disclosed herein may have a weight average molecular weight (Mw, g/mol or Daltons) ranging from about 20,000 to about 300,000. In some examples of the pre-treatment composition 12, the polymeric binder is the polyester-polyurethane binder, and the polyester-polyurethane binder has a weight average molecular weight ranging from about 20,000 Mw to about 300,000 Mw. As examples, the weight average molecular weight can range from about 50,000 to about 500,000, from about 100,000 to about 400,000, or from about 150,000 to about 300,000.

The polyester-polyurethane binders disclosed herein may have an acid number that ranges from about 1 mg KOH/g to about 50 mg KOH/g. In some examples of the pre-treatment composition 12, the polymeric binder is the polyester-polyurethane binder, and the polyester-polyurethane binder has an acid number that ranges from about 1 mg KOH/g to about 50 mg KOH/g. As other examples, the acid number of the polyester-polyurethane binder can range from about 1 mg KOH/g to about 200 mg KOH/g, from about 2 mg KOH/g to about 100 mg KOH/g, or from about 3 mg KOH/g to about 50 mg KOH/g.

As used herein, the term “acid number” refers to the mass of potassium hydroxide (KOH) in milligrams that is used to neutralize one (1) gram of a particular substance. The test for determining the acid number of a particular substance may vary, depending on the substance. To determine the acid number of the polyester-polyurethane binder, a known amount of a sample of the polyester-polyurethane binder may be dispersed in water and the aqueous dispersion may be titrated with a polyelectrolyte titrant of a known concentration. In this example, a current detector for colloidal charge measurement may be used. An example of a current detector is the MUtek PCD-05 Smart Particle Charge Detector (available from BTG). The current detector measures colloidal substances in an aqueous sample by detecting the streaming potential as the sample is titrated with the polyelectrolyte titrant to the point of zero charge. An example of a suitable polyelectrolyte titrant is poly(diallyldimethylammonium chloride) (i.e., PolyDADMAC). It is to be understood that any suitable test for a particular component may be used.

The average particle size of the polyester-polyurethane binders disclosed herein may range from about 20 nm to about 500 nm. As examples, the sulfonated polyester-polyurethane binder can have an average particle size ranging from about 20 nm to about 500 nm, from about 50 nm to about 350 nm, or from about 100 nm to about 350 nm. The particle size of any solids herein, including the average particle size of the dispersed polymer binder, can be determined using a NANOTRAC® Wave device, from Microtrac, e.g., NANOTRAC® Wave II or NANOTRAC® 150, etc., which measures particles size using dynamic light scattering. Average particle size can be determined using particle size distribution data generated by the NANOTRAC® Wave device. As mentioned, the term “average particle size” may refer to a volume-weighted mean diameter of a particle distribution.

Other examples of the pre-treatment composition 12 include an anionic polyether-polyurethane binder. Examples of anionic polyether-polyurethanes that may be used include IMPRANIL® LP DSB 1069, IMPRANIL® DLE, IMPRANIL® DAH, or IMPRANIL® DL 1116 (Covestro (Germany)); or HYDRAN® WLS-201 or HYDRAN® WLS-201K (DIC Corp. (Japan)); or TAKELAC® W-6061T or TAKELAC® WS-6021 (Mitsui (Japan)).

Still other examples of the pre-treatment composition 12 include an anionic polycarbonate-polyurethane binder. Examples of anionic polycarbonate-polyurethanes that may be used as the polymeric binder include IMPRANIL® DLC-F or IMPRANIL® DL 2077 (Covestro (Germany)); or HYDRAN® WLS-213 (DIC Corp. (Japan)); or TAKELAC® W-6110 (Mitsui (Japan)).

Examples of cationic polyurethane binders include PRINTRITE™ DP 675, SANCURE™ 20051, and SANCURE™ 20072 (each of which is an aliphatic polyether cationic polyurethane polymer dispersion available from Lubrizol Corporation). Other examples of cationic polyurethane binders include RUCO-PUR® SLR (a self-crosslinking, cationic polyether polyurethane available from Rudolf Group), RUCO-PUR® SEC (a hydrophilic, cationic polyurethane and silicone available from Rudolf Group), and RUCO-PUR® SLY (a hydrophilic, cationic polyurethane available from Rudolf Group).

Examples of non-ionic polyurethane binders include RUCO-PUR® SPH (a hydrophilic, non-ionic polyurethane available from Rudolf Group) and RUCO-COAT® EC 4811 (an aqueous polyurethane/polyether dispersion available from Rudolf Group). Another example of a non-ionic polyurethane binder includes IMPRANIL® DLI (polyether-polyurethane available from Covestro).

Additional examples of the pre-treatment composition 12 include an acrylic latex binder. The acrylic latex binder includes latex particles. As used herein, the term “latex” refers to a stable dispersion of polymer particles in an aqueous medium. As such, the polymer (latex) particles may be dispersed in water or water and a suitable co-solvent. This aqueous latex dispersion may be incorporated into a suitable pre-treatment vehicle to form examples of the pre-treatment composition 12.

The acrylic latex binder may be anionic, cationic, or non-ionic depending upon the monomers used.

In some examples, the latex particles can include a polymerization product of monomers including: a copolymerizable surfactant; an aromatic monomer selected from styrene, an aromatic (meth)acrylate monomer, and an aromatic (meth)acrylamide monomer; and multiple aliphatic (meth)acrylate monomers or multiple aliphatic (meth)acrylamide monomers. The term “(meth)” indicates that the acrylamide, the acrylate, etc., may or may not include the methyl group. In one example, the latex particles can include a polymerization product of a copolymerizable surfactant such as HITENOL™ BC-10, BC-30, KH-05, or KH-10. In another example, the latex particles can include a polymerization product of styrene, methyl methacrylate, butyl acrylate, and methacrylic acid.

In another particular example, the latex particles can include a first heteropolymer phase and a second heteropolymer phase. The first heteropolymer phase is a polymerization product of multiple aliphatic (meth)acrylate monomers or multiple aliphatic (meth)acrylamide monomers. The second heteropolymer phase can be a polymerization product of an aromatic monomer with a cycloaliphatic monomer, wherein the aromatic monomer is an aromatic (meth)acrylate monomer or an aromatic (meth)acrylamide monomer, and wherein the cycloaliphatic monomer is a cycloaliphatic (meth)acrylate monomer or a cycloaliphatic (meth)acrylamide monomer. The second heteropolymer phase can have a higher glass transition temperature than the first heteropolymer phase. The first heteropolymer composition may be considered a soft polymer composition and the second heteropolymers composition may be considered a hard polymer composition.

The two phases can be physically separated in the latex particles, such as in a core-shell configuration, a two-hemisphere configuration, smaller spheres of one phase distributed in a larger sphere of the other phase, interlocking strands of the two phases, and so on.

The first heteropolymer composition can be present in the latex particles in an amount ranging from about 15 wt % to about 70 wt % of a total weight of the polymer (latex) particle and the second heteropolymer composition can be present in an amount ranging from about 30 wt % to about 85 wt % of the total weight of the polymer particle. In other examples, the first heteropolymer composition can be present in an amount ranging from about 30 wt % to about 40 wt % of a total weight of the polymer particle and the second heteropolymer composition can be present in an amount ranging from about 60 wt % to about 70 wt % of the total weight of the polymer particle. In one specific example, the first heteropolymer composition can be present in an amount of about 35 wt % of a total weight of the polymer particle and the second heteropolymers composition can be present in an amount of about 65 wt % of the total weight of the polymer particle.

As mentioned herein, the first heteropolymer phase can be polymerized from two or more aliphatic (meth)acrylate ester monomers or two or more aliphatic (meth)acrylamide monomers. The aliphatic (meth)acrylate ester monomers may be linear aliphatic (meth)acrylate ester monomers and/or cycloaliphatic (meth)acrylate ester monomers. Examples of the linear aliphatic (meth)acrylate ester monomers can include ethyl acrylate, ethyl methacrylate, benzyl acrylate, benzyl methacrylate, propyl acrylate, propyl methacrylate, isopropyl acrylate, isopropyl methacrylate, butyl acrylate, butyl methacrylate, isobutyl acrylate, isobutyl methacrylate, hexyl acrylate, hexyl methacrylate, isooctyl acrylate, isooctyl methacrylate, octadecyl acrylate, octadecyl methacrylate, lauryl acrylate, lauryl methacrylate, hydroxyethyl acrylate, hydroxyethyl methacrylate, hydroxyhexyl acrylate, hydroxyhexyl methacrylate, hydroxyoctadecyl acrylate, hydroxyoctadecyl methacrylate, hydroxylauryl methacrylate, hydroxylauryl acrylate, 2-ethylhexyl acrylate, 2-ethylhexyl methacrylate, and combinations thereof. Examples of the cycloaliphatic (meth)acrylate ester monomers can include cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, and combinations thereof.

Also as mentioned herein, the second heteropolymer phase can be polymerized from a cycloaliphatic monomer and an aromatic monomer. The cycloaliphatic monomer can be a cycloaliphatic (meth)acrylate monomer or a cycloaliphatic (meth)acrylamide monomer. The aromatic monomer can be an aromatic (meth)acrylate monomer or an aromatic (meth)acrylamide monomer. The cycloaliphatic monomer of the second heteropolymer phase can be cyclohexyl acrylate, cyclohexyl methacrylate, methylcyclohexyl acrylate, methylcyclohexyl methacrylate, trimethylcyclohexyl acrylate, trimethylcyclohexyl methacrylate, tert-butylcyclohexyl acrylate, tert-butylcyclohexyl methacrylate, or a combination thereof. In still further examples, the aromatic monomer of the second heteropolymer phase can be 2-phenoxyethyl methacrylate, 2-phenoxyethyl acrylate, phenyl propyl methacrylate, phenyl propyl acrylate, benzyl methacrylate, benzyl acrylate, phenylethyl methacrylate, phenylethyl acrylate, benzhydryl methacrylate, benzhydryl acrylate, 2-hydroxy-3-phenoxypropyl acrylate, 2-hydroxy-3-phenoxypropyl methacrylate, N-benzyl methacrylamide, N-benzyl acrylamide, N,N-diphenyl methacrylamide, N,N-diphenyl acrylamide, naphthyl methacrylate, naphthyl acrylate, phenyl methacrylate, phenyl acrylate, or a combination thereof.

The latex particles can have a particle size ranging from 20 nm to 500 nm, from 50 nm to 350 nm, or from 150 nm to 270 nm.

In some examples, the latex particles can be prepared by flowing multiple monomer streams into a reactor. An initiator can also be included in the reactor. The initiator may be selected from a persulfate, such as a metal persulfate or an ammonium persulfate. In some examples, the initiator may be selected from a sodium persulfate, ammonium persulfate or potassium persulfate. The preparation process may be performed in water, resulting in the aqueous latex dispersion.

Example of anionic acrylic latex binders include JANTEX™ Binder 924 and JANTEX™ Binder 45 NRF (both of which are available from Jantex). Other examples of anionic acrylic latex binders include TEXICRYL™ 13-216, TEXICRYL™13-217, TEXICRYL™13-220, TEXICRYL™13-294, TEXICRYL™ 13-295, TEXICRYL™13-503, and TEXICRYL™13-813 (each of which is available from Scott Bader). Still other examples of anionic acrylic latex binders include TUBIFAST™ AS 4010 FF, TUBIFAST™ AS 4510 FF, and TUBIFAST™ AS 5087 FF (each of which is available from CHT).

Examples of cationic acrylic latex binders include TEXICRYL™ 13-400 and TEXICRYL™ 13-420 (both of which are available from Scott Bader). Other examples of cationic acrylic latex binders include OTTOPOL™ K-362 and OTTOPOL™ K-633 (both of which are available from Gellner Industrial). Still another example of a cationic acrylic latex binder includes CRILAT™ 4896 (available from Vinavil).

Examples of non-ionic acrylic latex binders include PRINTRITE™ 595, PRINTRITE™ 2015, PRINTRITE™ 2514, PRINTRITE™ 9691, and PRINTRITE™ 96155 (each of which is available from Lubrizol Corporation). Another example of a non-ionic acrylic latex binder includes TEXICRYL™ 13-440 (available from Scott Bader).

In some examples of the pre-treatment composition 12, the polymeric binder is present in an amount ranging from about 1 wt % active to about 20 wt % active, based on a total weight of the pre-treatment composition 12. In other examples, the polymeric binder can be present, in the pre-treatment composition 12, in an amount ranging from about 2 wt % active to about 15 wt % active, or from about from about 3 wt % active to about 11 wt % active, or from about 4 wt % active to about 10 wt % active, or from about 5 wt % active to about 9 wt % active, each of which is based on the total weight of the pre-treatment composition 12.

The polymeric binder (prior to being incorporated into the pre-treatment composition 12) may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the binder dispersion become part of the pre-treatment vehicle in the pre-treatment composition 12.

### Pre-Treatment Vehicle

As noted in the examples of the pre-treatment composition 12 disclosed herein, the pre-treatment composition 12 either i) includes the wax emulsion, and the wax emulsion is present in an amount ranging from about 1 wt % to about 40 wt % based on a total weight of the pre-treatment composition 12, or ii) the pre-treatment composition 12 includes the fluorinated polymer emulsion, and the fluorinated polymer emulsion is present in an amount ranging from about 0.5 wt % to about 20 wt % based on a total weight of the pre-treatment composition 12. As also noted in some examples of the pre-treatment composition 12 disclosed herein, the pre-treatment composition 12 may further include the polymeric binder.

Whether a vehicle is used in the pre-treatment composition 12 in addition to the emulsion (and, in some instances, the polymeric binder) depends, in part, upon the non-volatile solids (the wt % of active wax or fluorinated polymer or the wt % of active wax or fluorinated polymer plus the wt % of active polymeric binder) of the emulsion. The wax or fluorinated polymer emulsion is an aqueous emulsion, and water may be added in order to dilute the wax or fluorinated polymer emulsion to a desirable solids (the wt % of active wax or fluorinated polymer or the wt % of active wax or fluorinated polymer plus the wt % of active polymeric binder) content for the analog or digital application that is to be used to apply the pre-treatment composition 12. In some examples, water alone is the vehicle that is added to the wax or fluorinated polymer emulsion to generate the pre-treatment composition 12. In other examples, the wax or fluorinated polymer emulsion is an aqueous emulsion, and the pre-treatment composition 12 further includes a co-solvent, a surfactant, and additional water (e.g., to achieve a desirable solids content). In still other examples, the wax or fluorinated polymer emulsion is an aqueous emulsion, and the pre-treatment composition 12 further includes a co-solvent, a surfactant, an antimicrobial agent and additional water (e.g., to achieve a desirable solids content).

The co-solvent in the pre-treatment composition 12 may be a water soluble or water miscible co-solvent. Examples of co-solvents include alcohols, amides, esters, ketones, lactones, and ethers. In additional detail, the co-solvent may include aliphatic alcohols, aromatic alcohols, diols, glycol ethers, polyglycol ethers, caprolactams, formam ides, acetam ides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers (e.g., DOWANOL™ TPM (from Dow Chemical), higher homologs (C₆-C₁₂) of polyethylene glycol alkyl ethers, N-alkyl caprolactams, unsubstituted caprolactams, both substituted and unsubstituted formamides, both substituted and unsubstituted acetam ides, and the like. Specific examples of alcohols may include ethanol, isopropyl alcohol, butyl alcohol, and benzyl alcohol. Other specific examples include 2-ethyl-2-(hydroxymethyl)-1,3-propane diol (EPHD), dimethyl sulfoxide, sulfolane, and/or alkyldiols such as 1,2-hexanediol.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

In one specific example of the pre-treatment composition 12, the co-solvent includes 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof.

The co-solvent(s) may be present in an amount ranging from about 4 wt % to about 30 wt % (based on the total weight of the pre-treatment composition 12). In an example, the total amount of co-solvent(s) present in the pre-treatment composition 12 is about 10 wt % (based on the total weight of the pre-treatment composition 12).

The vehicle of the pre-treatment composition 12 may also include surfactant(s) (in addition to any surfactant present in the emulsion). In any of the examples disclosed herein, the surfactant may be present in an amount ranging from about 0.01 wt % active to about 5 wt % active (based on the total weight of the pre-treatment composition 12). In an example, the surfactant is present in the pre-treatment composition 12 in an amount ranging from about 0.05 wt % active to about 3 wt % active, based on the total weight of the pre-treatment composition 12. In another example, the surfactant is present in the inkjet ink in an amount of about 0.3 wt % active, based on the total weight of the pre-treatment composition 12.

The surfactant may include anionic, cationic, and/or non-ionic surfactants. Similar to the polymeric binder, the surfactant selected may depend, in part, on the ionic state of the wax emulsion or the fluorinated polymer emulsion that is used. For example, when an anionic wax emulsion or an anionic fluorinated polymer emulsion is used, anionic and/or non-ionic surfactants may be used. As another example, when a cationic wax emulsion or a cationic fluorinated polymer emulsion is used, cationic and/or non-ionic surfactants may be used. As still another example, when a non-ionic wax emulsion or a non-ionic fluorinated polymer emulsion is used, anionic, cationic, and/or non-ionic surfactants may be used.

Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsul fonate, and dibutylphenylphenol disulfonate.

Examples of the cationic surfactant include quaternary ammonium salts, such as benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride, domiphen bromide, alkylbenzyldimethylammonium chlorides, distearyldimethylammonium chloride, diethyl ester dimethyl ammonium chloride, dipalmitoylethyl hydroxyethylmonium methosulfate, and ACCOSOFT® 808 (methyl (1) tallow amidoethyl (2) tallow imidazolinium methyl sulfate available from Stepan Company). Other examples of the cationic surfactant include amine oxides, such as lauryldimethylamine oxide, myristamine oxide, cocamine oxide, stearamine oxide, and cetamine oxide.

Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the pre-treatment vehicle may include a silicone-free alkoxylated alcohol surfactant such as, for example, TEGO® Wet 510 (Evonik Degussa) and/or a self-emulsifiable wetting agent based on acetylenic diol chemistry, such as, for example, SURFYNOL® SE-F (Evonik Degussa). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); ZONYL® FSO (a.k.a. CAPSTONE®, which is a water-soluble, ethoxylated non-ionic fluorosurfactant from DuPont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Company); and BYK® 345, BYK® 346, BYK® 347, BYK® 348, BYK® 349 (each of which is a silicone surfactant) (all of which are available from BYK Additives and Instruments).

The vehicle of the pre-treatment composition 12 may also include antimicrobial agent(s). Antimicrobial agents are also known as biocides and/or fungicides. In an example, the total amount of antimicrobial agent(s) in the pre-treatment composition 12 ranges from about 0.01 wt % active to about 0.05 wt % active (based on the total weight of the pre-treatment composition 12). In another example, the total amount of antimicrobial agent(s) in the pre-treatment composition 12 is about 0.044 wt % active (based on the total weight of the pre-treatment composition 12).

Examples of suitable antimicrobial agents include the NUOSEPT® (Ashland Inc.), UCARCIDE™ or KORDEK™ or ROCIMA™ (Dow Chemical Co.), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof.

Examples of the pre-treatment composition 12 disclosed herein have a viscosity ranging from about 1 centipoise (cP) to about 100 cP at a temperature ranging from 20° C. to 25° C. (measured at a shear rate of about 3,000 Hz, e.g., with a Hydramotion Viscolite viscometer). Depending upon the viscosity, the pre-treatment composition 12 may be applied on the textile fabric using an analog method or a digital method. It is to be understood that the viscosity of the pre-treatment composition 12 may be adjusted for the type of analog coater that is to be used.

As an example, when the pre-treatment composition 12 is to be applied with an analog applicator, the viscosity of the pre-treatment composition 12 may range from about 1 cP to about 100 cP (at 20° C. to 25° C. and a shear rate of about 3,000 Hz).

As another example, when the pre-treatment composition 12 is to be applied with a thermal inkjet printer or in a piezoelectric inkjet printer, the viscosity of the pre-treatment composition 12 may be adjusted for the type of printhead that is to be used (e.g., by adjusting the co-solvent level). When used in a thermal inkjet printer, the viscosity of the pre-treatment composition 12 may be modified to range from about 1 cP to about 9 cP (at 20° C. to 25° C. and a shear rate of about 3,000 Hz), and when used in a piezoelectric printer, the viscosity of the pre-treatment composition 12 may be modified to range from about 1 cP to about 20 cP (at 20° C. to 25° C. and a shear rate of about 3,000 Hz). The viscosity of the pre-treatment composition that is to be inkjet printed may also be adjusted based on the type of the printhead that is being used (e.g., low viscosity printheads, medium viscosity printheads, or high viscosity printheads).

The pH of the pre-treatment composition 12 that includes the wax emulsion may range from 2 to 10. The pH of the pre-treatment composition 12 that includes the fluorinated polymer emulsion may range from 2 to 6.

### Fixer Composition

A fixer composition 14 includes a cationic polymer and a fixer vehicle. In some examples, the fixer composition 14 consists of the cationic polymer and the fixer vehicle. In other examples, the fixer composition 14 may include additional components.

### Cationic Polymer

The cationic polymer included in the fixer composition 14 has a weight average molecular weight ranging from about 3,000 to about 3,000,000. Any weight average molecular weight throughout this disclosure is in Daltons. In some examples (e.g., when the fixer composition 14 is to be thermal inkjet printed), the cationic polymer included in the fixer composition 14 has a weight average molecular weight of 100,000 or less. This molecular weight enables the cationic polymer to be printed by thermal inkjet printheads. In some examples, the weight average molecular weight of the cationic polymer ranges from about 3,000 to about 40,000. It is expected that a cationic polymer with a weight average molecular weight higher than 100,000 can be used for examples of the fixer composition 14 applied by piezoelectric printheads and analog methods. As such, in other examples, the cationic polymer may have a weight average molecular weight higher than 100,000, such as, for example, up to 3,000,000.

Examples of the cationic polymer are selected from the group consisting of poly(diallyldimethylammonium chloride); poly(methylene-co-guanidine) anion, wherein the anion is selected from the group consisting of hydrochloride, bromide, nitrate, sulfate, and sulfonates; a polyamine; poly(dimethylamine-co-epichlorohydrin); a polyethylenimine; a polyamide epichlorohydrin resin; a polyamine epichlorohydrin resin; and a combination thereof. Some examples of commercially available polyamine epichlorohydrin resins may include CREPETROL™ 73, KYMENE™ 736, KYMENE™ 736NA, POLYCUP™ 7360, and POLYCUP™ 7360A, each of which is available from Solenis LLC.

In an example, the cationic polymer of the fixer composition 14 is present in an amount ranging from about 1 wt % active to about 15 wt % active based on a total weight of the pre-treatment composition. In further examples, the cationic polymer is present in an amount ranging from about 1 wt % active to about 10 wt % active; or from about 4 wt % active to about 8 wt % active; or from about 2 wt % active to about 7 wt % active; or from about 6 wt % active to about 10 wt % active, based on a total weight of the pre-treatment composition.

### Fixer Vehicle

As mentioned above, the fixer composition 14 also includes the fixer vehicle. As used herein, the term “fixer vehicle” may refer to the liquid in which the cationic polymer is mixed to form the fixer composition 14.

In an example of the fixer composition 14, the fixer vehicle includes a surfactant, a co-solvent, and a balance of water. In another example, the fixer composition 14 further comprises an additive selected from the group consisting of a chelating agent, a pH adjuster, and combinations thereof. As such, some examples of the fixer vehicle (and thus the fixer composition 14) include a surfactant, a co-solvent, a chelating agent, and/or a pH adjuster.

The surfactant in the fixer composition 14 may be any example of the non-ionic surfactants or the cationic surfactants set forth herein for the pre-treatment composition 12, in any amount set forth herein for the pre-treatment composition 12 (except that the amount(s) are based on the total weight of the fixer composition 14 instead of the pre-treatment composition 12).

The co-solvent in the fixer composition 14 may be any example of the co-solvents set forth herein for the pre-treatment composition 12, in any amount set forth herein for the pre-treatment composition 12 (except that the amount(s) are based on the total weight of the fixer composition 14 instead of the pre-treatment composition 12).

When included in the fixer composition 14, the chelating agent is present in an amount greater than 0 wt % active and less than or equal to 0.5 wt % active based on the total weight of the thermally curable inkjet ink. In an example, the chelating agent is present in an amount ranging from about 0.05 wt % active to about 0.2 wt % active based on the total weight of the fixer composition 14.

In an example, the chelating agent is selected from the group consisting of methylglycinediacetic acid, trisodium salt; 4,5-dihydroxy-1,3-benzenedisulfonic acid disodium salt monohydrate; ethylenediaminetetraacetic acid (EDTA); hexamethylenediamine tetra(methylene phosphonic acid), potassium salt; and combinations thereof. Methylglycinediacetic acid, trisodium salt (Na3MGDA) is commercially available as TRILON® M from BASF Corp. 4,5-dihydroxy-1,3-benzenedisulfonic acid disodium salt monohydrate is commercially available as TIRON™ monohydrate. Hexamethylenediamine tetra(methylene phosphonic acid), potassium salt is commercially available as DEQUEST® 2054 from Italmatch Chemicals.

A pH adjuster may also be included in the fixer composition 14. A pH adjuster may be included in the fixer composition 14 to achieve a desired pH (e.g., about 4) and/or to counteract any slight pH increase that may occur over time. In an example, the total amount of pH adjuster(s) in the fixer composition 14 ranges from greater than 0 wt % to about 0.1 wt % (based on the total weight of the fixer composition 14). In another example, the total amount of pH adjuster(s) in the fixer composition 14 is about 0.03 wt % (based on the total weight of the fixer composition 14).

An example of a suitable pH adjuster that may be used in the fixer composition 14 includes methane sulfonic acid.

Suitable pH ranges for examples of the fixer composition 14 can be less than pH 7, from pH 2 to less than pH 7, from pH 5.5 to less than pH 7, from pH 5 to pH 6.6, or from pH 5.5 to pH 6.6. In one example, the pH of the pre-treatment composition is pH 4.

The balance of the fixer composition 14 is water. As such, the weight percentage of the water present in the pre-treatment composition will depend, in part, upon the weight percentages of the other components. The water may be purified water or deionized water.

The viscosity of the fixer composition 14 may vary depending upon the application method that is to be used to apply the fixer composition 14. As an example, when the fixer composition 14 is to be applied with an analog applicator, the viscosity of the fixer composition 14 may range from about 20 centipoise (cP) to about 300 cP (at 20° C. to 25° C. and a shear rate of about 3,000 Hz). As other examples, when the fixer composition 14 is to be applied with an thermal inkjet applicator/printhead, the viscosity of the fixer composition 14 may range from about 1 cP to about 9 cP (at 20° C. to 25° C. and a shear rate of about 3,000 Hz), and when the fixer composition 14 is to be applied with an piezoelectric inkjet applicator/printhead, the viscosity of the fixer composition 14 may range from about 1 cP to about 20 cP (at 20° C. to 25° C. and a shear rate of about 3,000 Hz).

### Inkjet Ink

An inkjet ink 16 includes a white pigment, a polymeric binder, and an ink vehicle. In some examples, the inkjet ink 16 consists of the white pigment, the polymeric binder; and the ink vehicle. In other examples, the inkjet ink 16 may include additional components.

### White Pigments

The white pigment may be incorporated into the inkjet ink 16 as a white pigment dispersion. The white pigment dispersion may include a white pigment and a separate pigment dispersant.

For the white pigment dispersions disclosed herein, it is to be understood that the white pigment and separate pigment dispersant (prior to being incorporated into the ink formulation), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 2,2-dimethyl-1,3-propanediol, 1,2-butane diol, diethylene glycol, 1,3-propanediol, 1,4-butanediol, 1,5-pentanediol, triethylene glycol, tetraethylene glycol, hexylene glycol, or a combination thereof. It is to be understood however, that the liquid components of the white pigment dispersion become part of the ink vehicle in the inkjet ink 16.

Examples of suitable white pigments include white metal oxide pigments, such as titanium dioxide (TiO₂), zinc oxide (ZnO), zirconium dioxide (ZrO₂), or the like. In one example, the white pigment is titanium dioxide. In an example, the titanium dioxide is in its rutile form.

In some examples, the white pigment may include white metal oxide pigment particles coated with silicon dioxide (SiO₂). In one example, the white metal oxide pigment content to silicon dioxide content can be from 100:3.5 to 5:1 by weight. In other examples, the white pigment may include white metal oxide pigment particles coated with silicon dioxide (SiO₂) and aluminum oxide (Al₂O₃). In one example, the white metal oxide pigment content to total silicon dioxide and aluminum oxide content can be from 50:3 to 4:1 by weight. One example of the white pigment includes TI-PURE® R960 (TiO₂ pigment powder with 5.5 wt % silica and 3.3 wt % alumina (based on pigment content)) available from Chemours. Another example of the white pigment includes TI-PURE® R931 (TiO₂ pigment powder with 10.2 wt % silica and 6.4 wt % alumina (based on pigment content)) available from Chemours. Still another example of the white pigment includes TI-PURE® R706 (TiO₂ pigment powder with 3.0 wt % silica and 2.5 wt % alumina (based on pigment content)) available from Chemours.

The white pigment may have high light scattering capabilities, and the average particle size of the white pigment may be selected to enhance light scattering and lower transmittance, thus increasing opacity. The average particle size of the white pigment may range anywhere from about 100 nm to about 2000 nm. In some examples, the average particle size ranges from about 120 nm to about 2000 nm, from about 150 nm to about 1000 nm, from about 150 nm to about 750 nm, or from about 200 nm to about 500 nm. The term “average particle size”, as used herein, may refer to a volume-weighted mean diameter of a particle distribution.

In an example, the white pigment is present in an amount ranging from about 3 wt % active to about 20 wt % active, based on a total weight of the inkjet ink 16. In other examples, the white pigment is present in an amount ranging from about 5 wt % active to about 20 wt % active, or from about 5 wt % active to about 15 wt % active, based on a total weight of the inkjet ink 16. In still another example, the white pigment is present in an amount of about 10 wt % active or about 9.75 wt % active, based on a total weight of the inkjet ink 16.

### Pigment Dispersants

The white pigment may be dispersed with the pigment dispersant. In an example, the pigment dispersant is selected from the group consisting of a water-soluble acrylic acid polymer, a branched co-polymer of a comb-type structure with polyether pendant chains and acidic anchor groups attached to a backbone, and a combination thereof.

Some examples of the water-soluble acrylic acid polymer include CARBOSPERSE® K7028 (polyacrylic acid having a weight average molecular weight (Mw) of about 2,300), CARBOSPERSE® K752 (polyacrylic acid having a weight average molecular weight (Mw) of about 2,000), CARBOSPERSE® K7058 (polyacrylic acid having a weight average molecular weight (Mw) of about 7,300), and CARBOSPERSE® K732 (polyacrylic acid having a weight average molecular weight (Mw) of about 6,000), all available from Lubrizol Corporation.

Some examples of the branched co-polymer of the comb-type structure with polyether pendant chains and acidic anchor groups attached to the backbone include DISPERBYK®-190 (an acid number of about 10 mg KOH/g) and DISPERBYK®-199, both available from BYK Additives and Instruments, as well as DISPERSOGEN® PCE available from Clariant.

In some examples, the pigment dispersant is present in an amount ranging from about 0.05 wt % active to about 1 wt % active, based on a total weight of the inkjet ink 16. In one of these examples, the dispersant is present in an amount of about 0.23 wt % active, based on a total weight of the inkjet ink 16.

In some examples, the pigment dispersant includes both the water-soluble acrylic acid polymer and the branched co-polymer of the comb-type structure with polyether pendant chains and acidic anchor groups attached to the backbone. In some of these examples, the pigment dispersant includes CARBOSPERSE® K7028 and DISPERBYK°-190. In some of these examples, the pigment dispersant includes both the water-soluble acrylic acid polymer and the branched co-polymer of the comb-type structure with polyether pendant chains and acidic anchor groups attached to the backbone, where the water-soluble acrylic acid polymer is present in an amount ranging from about 0.02 wt % active to about 0.4 wt % active, and the branched co-polymer of the comb-type structure with polyether pendant chains and acidic anchor groups attached to the backbone is present in an amount ranging from about 0.03 wt % active to about 0.6 wt % active. In one of these examples, the water-soluble acrylic acid polymer is present in an amount of about 0.09 wt % active, and the branched co-polymer of the comb-type structure with polyether pendant chains and acidic anchor groups attached to the backbone is present in an amount of about 0.14 wt % active.

### Polymeric Binder

The inkjet ink 16 also includes a polymeric binder. The polymeric binder in the inkjet ink 16 may be any example of the anionic polymeric binders or the non-ionic polymeric binder set forth herein for the pre-treatment composition 12, in any amount set forth herein for the pre-treatment composition 12 (except that the amount(s) are based on the total weight of the inkjet ink 16 instead of the pre-treatment composition 12).

The polymeric binder (prior to being incorporated into the inkjet ink 16) may be dispersed in water alone or in combination with an additional water soluble or water miscible co-solvent, such as those described for the pigment dispersion. It is to be understood however, that the liquid components of the binder dispersion become part of the ink vehicle in the inkjet ink 16.

### Ink Vehicle

In addition to the pigment and the polymeric binder, the inkjet ink 16 includes an ink vehicle.

As used herein, the term “ink vehicle” may refer to the liquid with which the pigment (dispersion) and polymeric binder (dispersion) are mixed to form a thermal or a piezoelectric inkjet ink(s) composition. A wide variety of vehicles may be used with the ink composition(s) of the present disclosure. The ink vehicle may include water and any of: a co-solvent, an anti-kogation agent, an anti-decel agent, a surfactant, an antimicrobial agent, a pH adjuster, or combinations thereof. In an example of the ink inkjet ink, the vehicle includes water and a co-solvent. In another example, the vehicle consists of water and the co-solvent, the anti-kogation agent, the anti-decel agent, the surfactant, the antimicrobial agent, a pH adjuster, or a combination thereof. In still another example, the ink vehicle consists of the anti-kogation agent, the anti-decel agent, the surfactant, the antimicrobial agent, a pH adjuster, and water.

The co-solvent in the inkjet ink 16 may be any example of the co-solvents set forth herein for the pre-treatment composition 12, in any amount set forth herein for the pre-treatment composition 12 (except that the amount(s) are based on the total weight of the inkjet ink 16 instead of the pre-treatment composition 12).

The surfactant in the inkjet ink 16 may be any example of the anionic or non-ionic surfactants set forth herein for the pre-treatment composition 12, in any amount set forth herein for the pre-treatment composition 12 (except that the amount(s) are based on the total weight of the inkjet ink 16 instead of the pre-treatment composition 12).

An anti-kogation agent may also be included in the vehicle of the inkjet ink 16, for example, when the inkjet ink 16 is to be applied via a thermal inkjet printhead. Anti-kogation agent(s) is/are included to assist in preventing the buildup of kogation. In some examples, the anti-kogation agent may improve the jettability of the inkjet ink 16. The anti-kogation agent may be present in the inkjet ink 16 in an amount ranging from about 0.1 wt % active to about 1.5 wt % active, based on the total weight of the inkjet ink 16. In an example, the anti-kogation agent is present in an amount of about 0.5 wt % active, based on the total weight of the inkjet ink 16.

Examples of suitable anti-kogation agents include oleth-3-phosphate (commercially available as CRODAFOS™ O3A or CRODAFOS™ N-3A) or dextran 500k. Other suitable examples of the anti-kogation agents include CRODAFOS™ HCE (phosphate-ester from Croda Int.), CRODAFOS® O10A (oleth-10-phosphate from Croda Int.), or DISPERSOGEN® LFH (polymeric dispersing agent with aromatic anchoring groups, acid form, anionic, from Clariant), etc. It is to be understood that any combination of the anti-kogation agents listed may be used.

The antimicrobial agent in the inkjet ink 16 may be any example of the antimicrobial agent set forth herein for the pre-treatment composition 12, in any amount set forth herein for the pre-treatment composition 12 (except that the amount(s) are based on the total weight of the inkjet ink 16 instead of the pre-treatment composition 12).

The ink vehicle may also include anti-decel agent(s). The anti-decel agent may function as a humectant. Decel refers to a decrease in drop velocity over time with continuous firing. In the examples disclosed herein, the anti-decel agent(s) is/are included to assist in preventing decel. In some examples, the anti-decel agent may improve the jettability of the inkjet ink 16. The anti-decel agent(s) may be present in an amount ranging from about 0.2 wt % active to about 5 wt % active (based on the total weight of the inkjet ink 16). In an example, the anti-decel agent is present in the inkjet ink 16 in an amount of about 1 wt % active, based on the total weight of the inkjet ink 16.

An example of a suitable anti-decel agent is ethoxylated glycerin having the following formula:

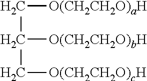

in which the total of a+b+c ranges from about 5 to about 60, or in other examples, from about 20 to about 30. An example of the ethoxylated glycerin is LIPON IC® EG-1 (LEG-1, glycereth-26, a+b+c=26, available from Lipo Chemicals).

The ink vehicle of the inkjet ink 16 may also include a pH adjuster. A pH adjuster may be included in the inkjet ink 16 to achieve a desired pH of greater than 7. Suitable pH ranges for examples of the ink composition can be from greater than pH 7 to pH 11, from greater than pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8.

The type and amount of pH adjuster that is added to the ink composition may depend upon the initial pH of the ink composition and the desired final pH of the ink composition. If the initial pH is too high, an acid may be added to lower the pH, and if the initial pH is too low, a base may be added increase the pH. Examples of suitable pH adjusters include metal hydroxide bases, such as potassium hydroxide (KOH), sodium hydroxide (NaOH), etc. In an example, the metal hydroxide base may be added to the inkjet ink 16 in an aqueous solution. In another example, the metal hydroxide base may be added to the inkjet ink 16 in an aqueous solution including 5 wt % of the metal hydroxide base (e.g., a 5 wt % potassium hydroxide aqueous solution).

In an example, the total amount of pH adjuster(s) in the inkjet ink 16 ranges from greater than 0 wt % to about 0.1 wt % (based on the total weight of the inkjet ink 16). In another example, the total amount of pH adjuster(s) in the inkjet ink 16 is about 0.03 wt % (based on the total weight of the inkjet ink 16).

In some instances, other suitable inkjet ink additives may be included in the inkjet ink 16, such as sequestering agents (e.g., EDTA (ethylene diamine tetra acetic acid) to eliminate the deleterious effects of heavy metal impurities, and viscosity modifiers to modify properties of the ink as desired.

The balance of the inkjet ink 16 is water. In an example, purified water or deionized water may be used. The water included in the inkjet ink 16 may be: i) part of the pigment dispersion, and/or binder dispersion, ii) part of the ink vehicle, iii) added to a mixture of the pigment dispersion, and/or binder dispersion and the ink vehicle, or iv) a combination thereof. In examples where the inkjet ink 16 is a thermal inkjet ink, the ink vehicle includes at least 70% by weight of water. In examples where the ink composition is a piezoelectric inkjet ink, the liquid vehicle is a solvent based vehicle including at least 50% by weight of the co-solvent.

One specific example of the inkjet ink 16 includes the pigment in an amount ranging from about 1 wt % active to about 10 wt % active based on the total weight of the inkjet ink 16; the polymeric binder in an amount ranging from about 2 wt % active to about 10 wt % active of the total weight of the inkjet ink 16; an additive selected from the group consisting of a non-ionic surfactant, an antimicrobial agent, an anti-decel agent, and combinations thereof; and the liquid vehicle, which includes water and an organic solvent (e.g., the co-solvent disclosed herein).

Examples of the inkjet ink 16 disclosed herein may be used in a thermal inkjet printer or in a piezoelectric printer. The viscosity of the inkjet ink 16 may be adjusted for the type of printhead by adjusting the co-solvent level, adjusting the polymeric binder level, and/or adding a viscosity modifier. When used in a thermal inkjet printer, the viscosity of the inkjet ink 16 may be modified to range from about 1 cP to about 9 cP (at 20° C. to 25° C. measured at a shear rate of about 3,000 Hz). When used in a piezoelectric printer, the viscosity of the inkjet ink 16 may be modified to range from about 1 cP to about 20 cP (at 20° C. to 25° C. measured at a shear rate of about 3,000 Hz), depending on the type of the printhead that is being used (e.g., low viscosity printheads, medium viscosity printheads, or high viscosity printheads).

### Textile Fabrics

In the examples disclosed herein, the textile fabric 18 may be selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof. In a further example, the textile fabric 18 is selected from the group consisting of cotton fabrics and cotton blend fabrics.

It is to be understood that organic textile fabrics and/or inorganic textile fabrics may be used for the textile fabric 18. Some types of fabrics that can be used include various fabrics of natural and/or synthetic fibers. It is to be understood that the polyester fabrics may be a polyester coated surface. The polyester blend fabrics may be blends of polyester and other materials (e.g., cotton, linen, etc.). In another example, the textile fabric 18 may be selected from nylons (polyamides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric/substrate 18 can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E.I. du Pont de Nemours and Company, Delaware), fiberglass, polytrimethylene, polycarbonate, polyethylene terephthalate, polyester terephthalate, polybutylene terephthalate, or a combination thereof. In an example, natural and synthetic fibers may be combined at ratios of 1:1, 1:2, 1:3, 1:4, 1:5, 1:6, 1:7, 1:8, 1:9, 1:10, 1:11, 1:12, 1:13, 1:14, 1:15, 1:16, 1:17, 1:18, 1:19, 1:20, or vice versa. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

In addition, the textile fabric 18 can contain additives, such as a colorant (e.g., pigments, dyes, and tints), an antistatic agent, a brightening agent, a nucleating agent, an antioxidant, a UV stabilizer, a filler, and/or a lubricant, for example.

It is to be understood that the terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

In one example, the textile fabric 18 can have a basis weight ranging from 10 gsm to 500 gsm. In another example, the textile fabric 18 can have a basis weight ranging from 50 gsm to 400 gsm. In other examples, the textile fabric 18 can have a basis weight ranging from 100 gsm to 300 gsm, from 75 gsm to 250 gsm, from 125 gsm to 300 gsm, or from 150 gsm to 350 gsm.

The textile fabric 18 may be any color, and in example is a color other than white.

### Printing Method and System

FIG. 2 depicts an example of the printing method 100. As shown in FIG. 2, an example of the printing method 100 comprises: generating a print by: applying a pre-treatment composition 12 on a textile fabric 18 to form a pre-treatment composition layer, the pre-treatment composition including a wax emulsion or a fluorinated polymer emulsion; applying heat and pressure to the pre-treatment composition layer on the textile fabric 18 to form a pre-treatment film; inkjet printing a fixer composition 14 on the pre-treatment film to form a fixer layer, the fixer composition including a cationic polymer and a fixer vehicle; and inkjet printing an inkjet ink 16 on the fixer layer to form an ink layer, the inkjet ink 16 including a white pigment, a polymeric binder, and an ink vehicle (as shown at reference numeral 102); and thermally curing the print (as shown at reference numeral 104).

It is to be understood that any example of the pre-treatment composition 12, the fixer composition 14, and the inkjet ink 16 may be used in the examples of the method 100. Further, it is to be understood that any example of the textile fabric 18 may be used in the examples of the method 100.

As shown in reference numeral 102 in FIG. 2, the method 100 includes generating the print.

When generating the print, the pre-treatment composition 12 is applied to the textile fabric 18 and then is exposed to heat and pressure. The application of the pre-treatment composition 12 may be accomplished via an analog method or via a digital inkjet printing method.

When an analog method is used, the pre-treatment composition 12 may be applied using an auto analog pretreater, a drawdown coater, a slot die coater, a roller coater, a fountain curtain coater, a blade coater, a rod coater, an air knife coater, a sprayer, or a gravure application. In these examples, the pre-treatment composition may be coated on all or substantially all of the textile fabric 18. As such, the pre-treatment composition layer that is formed may be a continuous layer that covers all or substantially all of the textile fabric.

When a digital inkjet printing method is used, the pre-treatment composition 12 may be applied using thermal inkjet printing or piezoelectric inkjet printing. Any suitable inkjet applicator, such as a thermal inkjet printhead, a piezoelectric printhead, a continuous inkjet printhead, etc. may be used. In these examples, the pre-treatment composition 12 may be printed at desirable areas. As such, the pre-treatment composition layer that is formed by the application of the pre-treatment composition 12 may be non-continuous. In other words, the pre-treatment composition layer may contain gaps where no pre-treatment composition is printed.

In an example, the pre-treatment composition 12 is applied in an amount less than 100 gsm. In another example, the pre-treatment composition 12 is applied in an amount less than 75 gsm. In still another example, the pre-treatment composition 12 is applied in an amount ranging from about 60 gsm to about 70 gsm.

The pre-treatment composition layer 12 is then exposed to heat and pressure. The application of heat and pressure may be accomplished using a heat press, an iron, or another suitable mechanism. In an example of the method 100, the application of heat and pressure involves heating the textile fabric 18 (with the pre-treatment composition 12 applied thereon) to a temperature for a period of time and at a pressure. The heat applied to pre-treatment composition layer 12 on the textile fabric 18 ranges from about 80° C. to about 200° C. The pressure applied to the pre-treatment composition layer 12 on the textile fabric 18 ranges from about 0.1 atm to about 8 atm. The heat and the pressure are applied to pre-treatment composition layer 12 on the textile fabric 18 for a period of time ranging from about 10 seconds to about 30 minutes. In one example, the temperature ranges from about 100° C. to about 150° C., the pressure ranges from about 0.5 atm to about 5 atm, and the time ranges for about 1 minute to about 30 minutes.

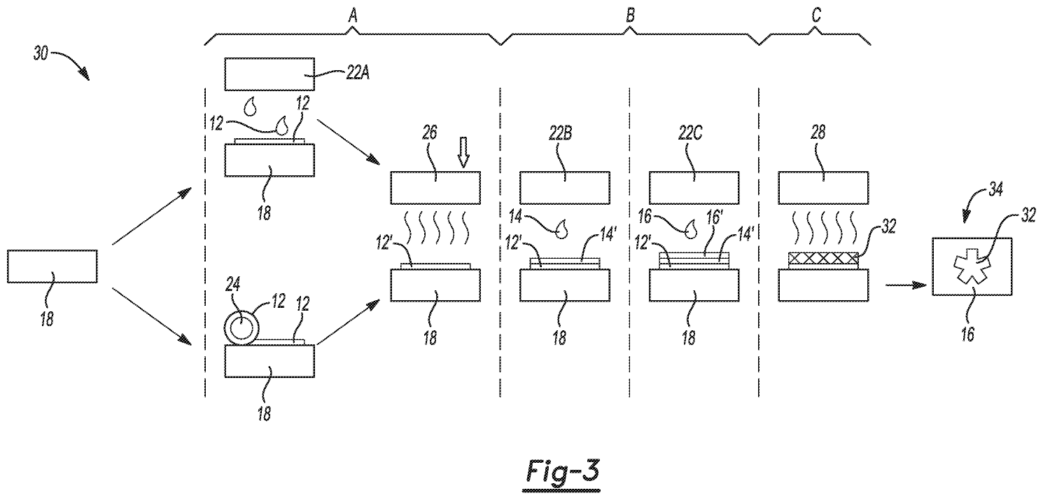

During the application of heat and pressure, the wax from the wax emulsion or the fluorinated polymer from the fluorinated polymer emulsion in the pre-treatment composition 12 coalesces to form a pre-treatment film (see 12′ in FIG. 3). Wax or polymer coalescence forms the film 12′ on the surfaces of the textile fabric fibers and/or in the pores between the textile fabric fibers. This film 12′ renders the textile fabric 18 more hydrophobic than the textile fabric 18 is without the film. The wax or polymer film can slow down ink penetration into the textile fabric 18, which allows the pigment of the inkjet ink 16 to be fixed, through its interaction with the fixer composition 14, at or near the surface of the textile fabric 18. This, in turn, improves the opacity and the image quality of the white image that is formed. Moreover, the film can hold the hair-like fibers of the textile fabric 18, which reduces fibrillation and improves image quality.

In some examples, (such as when the pre-treatment composition 12 includes the fluorinated polymer emulsion, and the fluorinated polymer in the fluorinated polymer emulsion is a perfluoroacrylated polymer) the pre-treatment composition 12 may be applied to increase the oil resistance of the textile fabrics. In these examples, the fixer composition 14 and the inkjet ink 16 may or may not be applied on the pre-treatment composition layer 12.

As shown in reference numeral 102 in FIG. 2, generating the print also includes applying the fixer composition 14 on the pre-treatment film 12′ to form a fixer layer. The application of the fixer composition 14 may be accomplished via an analog method or via a digital inkjet printing method. The method used may depend upon the viscosity of the fixer composition 14.

In an example, the fixer composition 14 is applied in an amount ranging from about 50 gsm to about 75 gsm.

As shown in reference numeral 102 in FIG. 2, generating the print also includes inkjet printing the inkjet ink 16 on the fixer layer. It is to be understood that the inkjet ink 16 is printed at desirable areas to form an image.

In an example, the inkjet ink 16 is applied in an amount ranging from about 200 gsm to about 400 gsm. In another example, the inkjet ink 16 is applied in an amount ranging from about 200 gsm to about 350 gsm.

In some examples, multiple inkjet inks (including white inkjet ink 16) may be inkjet printed onto the textile fabric 18. In these examples, each of the other inkjet inks may include a pigment, an example of the polymeric binder, and the ink vehicle. Each of the inkjet inks may include a different colored pigment so that a different color (e.g., cyan, magenta, yellow, black, violet, green, brown, orange, purple, etc.) is generated by each of the inkjet inks.

In other examples, a single white inkjet ink 16 may be inkjet printed onto the textile fabric 18.

In some examples of the method 100, both the fixer composition 14 and the inkjet ink 16 are applied using inkjet printing. As an example, the fixer composition 14 and the inkjet ink 16 are applied sequentially one immediately after the other as the applicators (e.g., cartridges, pens, printheads, etc.) pass over the textile fabric 18.

In some examples of the method 100, the inkjet ink 16 is printed onto the fixer layer while the fixer layer is wet. Wet on wet printing may be desirable because less fixer composition 14 may be applied during this process (as compared to when the pre-fixer composition 14 is dried prior to inkjet ink 16 application), and because the printing workflow may be simplified without the additional drying. In an example of wet on wet printing, the inkjet ink 16 is printed onto the fixer layer within a period of time ranging from about 0.01 second to about 30 seconds after the fixer composition 16 is printed. In further examples, the inkjet ink 16 is printed onto the fixer layer within a period of time ranging from about 0.1 second to about 20 seconds; or from about 0.2 second to about 10 seconds; or from about 0.2 second to about 5 seconds after the fixer composition 14 is applied to form the fixer layer. Wet on wet printing may be accomplished in a single pass.

In another example of the method 100, drying takes place after the application of the fixer composition 14 and before the application of the inkjet ink 16. As such, the fixer composition 14 may be dried on the textile fabric 18 before the inkjet ink 16 is applied. It is to be understood that in this example, drying of the fixer composition 16 may be accomplished in any suitable manner, e.g., air dried (e.g., at a temperature ranging from about 20° C. to about 80° C. for 30 seconds to 5 minutes), exposure to electromagnetic radiation (e.g. infra-red (IR) radiation for 5 seconds), and/or the like. When drying is performed, the fixer composition 14 and the inkjet ink 16 may be applied in separate passes to allow time for the drying to take place.

In some examples of the method 100, the inkjet printing of the pre-treatment composition 12, the fixer composition 14, and/or the inkjet ink 16 may be accomplished at high printing speeds. In an example, the inkjet printing of the pre-treatment composition 12, the fixer composition 14, and/or the inkjet ink 16 may be accomplished at a printing speed of at least 25 feet per minute (fpm). In another example, the pre-treatment composition 12, the fixer composition 14, and/or the inkjet ink 16 may be inkjet printed a printing speed ranging from 100 fpm to 1000 fpm.

As shown in reference numeral 104 in FIG. 1, the method 100 includes thermally curing the print. The thermal curing of the print may be accomplished by applying heat to the print. In an example of the method 100, the thermal curing involves heating the print to a temperature ranging from about 80° C. to about 200° C., for a period of time ranging from about 10 seconds to about 15 minutes. In another example, the temperature ranges from about 100° C. to about 180° C. In still another example, thermal curing is achieved by heating the print to a temperature of 150° C. for about 3 minutes.

Referring now to FIG. 3, a schematic diagram of a printing system 30 is depicted. The printing system 30 includes three zones A, B, C, including a pre-treatment zone A, a printing zone B, and a curing zone C.

In one example, a textile fabric/substrate 18 may be transported through the printing system 30 along one of two paths (as shown by the arrows) such that the textile fabric 18 is first fed to the pre-treatment zone A. In the pre-treatment zone A, an example of the pre-treatment composition 12 is applied to the textile fabric 18. In one example, the pre-treatment composition 12 is applied digitally by inkjet printhead 22A. In another example, the pre-treatment composition 12 is applied using an analog applicator 24 (e.g., an auto analog pretreater, a drawdown coater, a slot die coater, a roller coater, a fountain curtain coater, a blade coater, a rod coater, an air knife coater, a sprayer, or a gravure application).

The application of the pre-treatment composition 12 forms a pre-treatment composition layer 12 on the textile fabric 18. The pre-treatment composition layer 12 disposed on the textile fabric 18 is then exposed to heating and pressure in the pre-treatment zone A. The application of heat and pressure may be accomplished, for example, using a heat press 26 or other suitable heated mechanism that can be pushed into contact with pre-treatment composition layer 12. This process forms the pre-treatment film 12′.

The textile fabric 18 is then transported through a printing zone B where an example of the fixer composition 14 is first applied onto the pre-treatment film 12′. While the fixer composition 14 is shown being applied by an inkjet printhead 22B, it is to be understood that the fixer composition 14 may be applied by an analog applicator 24. In the printing zone B, the inkjet ink 16 is also applied to the fixer layer 14′ to from an ink layer 16′.

The fixer layer 14′ and the ink layer 16′ may be heated in the printing zone B (for example, the air temperature in the printing zone B may range from about 10° C. to about 90° C.) such that water may be at least partially evaporated from the layer 14′, 16′. The fixer layer 14′ may or may not be dried before the inkjet ink 16 is applied.

The textile fabric 18 (having the pre-treatment film 12′, the fixer layer 14′, and the ink layer 16′ thereon) may then be transported to the curing zone C where the compositions/layers are heated to cure the print. The heat is sufficient to initiate crosslinking or other interactions that bind the pigment onto the textile fabric 18. The heat to initiate fixation (thermal curing) may range from about 80° C. to 200° C. as described above. This process forms the printed article 34 including the image 32 formed on the textile fabric 18.

To further illustrate the present disclosure, examples are given herein. It is to be understood that these examples are provided for illustrative purposes and are not to be construed as limiting the scope of the present disclosure.

### EXAMPLES

### Example 1

Four examples of the pre-treatment composition disclosed herein were prepared with wax emulsions. To prepare the pre-treatment compositions, four different commercially available wax emulsions were diluted with deionized water to obtain fluids having 10 wt % active wax.

The surface tension, viscosity, pH, and average particle size (a volume-weighted mean diameter, Mᵥ (in microns)) were measured for each pre-treatment composition. The surface tension was measured by the Wilhelmy plate method with a Kruss tensiometer. The viscosity was measured at room temperature (25° C.) using a Viscolite viscometer. The particle size was measured using a NANOTRAC® Wave device, from Microtrac.

The pre-treatment compositions and their associated properties are shown in Table 1.

TABLE 1
Pre-Treatment Compositions

| | | Surface | Vis- | | Particle |
|---|---|---|---|---|---|
| PTC | | Tension | cosity | | Size, Mᵥ |
| ID | Wax Emulsion | (dynes/cm) | (cp) | pH | (μm) |
| 1 | 10 wt % active | 55.25 | 1.2 | 8.38 | 0.553 |
| | SEQUAPEL ® 417 | | | | |
| 2 | 10 wt % active | 57.55 | 1.1 | 6.54 | 0.282 |
| | LIQUILUBE ™ 405 | | | | |
| 3 | 10 wt % active | 46.67 | 1.4 | 8.89 | 0.323 |
| | AQUACER ® 494 | | | | |
| 4 | 10 wt % active | 35.76 | 1.6 | 4.18 | 0.441 |
| | AQUACER ® 497 | | | | |

Gildan black midweight 780 cotton T-shirts (having a basis weight of 180 gsm) were used as the textile fabric in this example.

Example pre-treated fabrics 1-4 were generated using the respective pre-treatment compositions 1-4. For each example pre-treated fabric, the corresponding pre-treatment composition (60 gsm to 70 gsm) was first applied to a piece of the fabric using a spraying technique. The pre-treated fabrics were exposed to 150° C. and pressure of 3 atm when pressed in a clam shell hot press for 1 minute.

Comp. fabric 5 was not pre-treated as it did not have pre-treatment composition applied thereto and was not exposed to pre-heating.

For comp. fabric 6, the black cotton fabric was exposed to pre-heating, but did not have any pre-treatment composition applied thereto prior to pre-heating.

Comp. fabrics 7 and 8 were generated using water as a pre-treatment fluid. For each of comp. fabrics 7 and 8, water was first applied to a piece of the fabric using a spraying technique. Comp. print 7 was exposed to 150° C. and pressure of 3 atm when pressed in a clam shell hot press for 1 minute. Comp. print 8 was squeegeed after the water was sprayed, and was not exposed to pre-heating.

The pre-treated and comparative fabrics were exposed to a water penetration test. During this test, the time it took for water to penetrate the pre-treated fabric or the comparative fabric was timed. A drop of water was put onto the pre-treated or comparative fabric using a pipette, and the time it took for the water to penetrate the fabric (i.e., completely soak into the fabric) was measured. These results are also shown in Table 2.

TABLE 2

| | Pre- | | | |
|---|---|---|---|---|
| | treatment | Pre- | Time for water to | |
| Fabric ID | (gsm) | Heating | penetrate fabric | |
| Ex. Pre-treated | PTC 1 | Heat press | >15 | min |
| Fabric 1 | (70.0) | 150° C., | | |
| | | 1 min | | |
| Ex. Pre-treated | PTC 2 | Heat press | 8 min, | |
| Fabric 2 | (68.2) | 150° C., | 5 sec | |
| | | 1 min | | |
| Ex. Pre-treated | PTC 3 | Heat press | 8 min, | |
| Fabric 3 | (59.6) | 150° C., | 54 sec | |
| | | 1 min | | |
| Ex. Pre-treated | PTC 4 | Heat press | 3 min, | |
| Fabric 4 | (63.2) | 150° C., | 35 sec | |
| | | 1 min | | |
| Comp. Fabric 5 | No fluid | None | <1 | s |
| Comp. Fabric 6 | No fluid | Heat press | <1 | s |
| | | 150° C., | | |
| | | 1 min | | |
| Comp. Fabric 7 | Water | Heat press | <1 | s |
| | (75.6) | 150° C., | | |
| | | 1 min | | |
| Comp. Fabric 8 | Water | None, | <1 | s |
| | (200) | squeegee | | |

Comp. fabric 5 was not pre-treated. The fabric surface was very porous and hydrophilic, as evidenced by the fact that a drop of water penetrated rapidly (e.g., <1 second) onto the fabric. In contrast, when the fabric was treated with <100 gsm of the wax pre-treatment compositions PTC 1 to PTC 4, the fabric surface became much more hydrophobic. As shown in Table 2 for ex. pre-treated fabrics 1 through 4, the hydrophobic surface greatly slowed down liquid penetration into the fabric. For each example pre-treated fabric, the drop of water stayed on the treated fabric surface for greater than 3 minutes.

Each of the pre-treated and comparative fabrics was then used to a generate print.

An example fixer composition as disclosed herein was prepared. The general formulation of the example fixer composition is shown in Table 3, with the wt % active of each component that was used.

TABLE 3
Fixer Composition

| Ingredient | Specific Component | wt % active |
|---|---|---|
| Co-solvent | 2-pyrrolidone | 12 |
| Cationic Polymer | POLYCUP ™ 7360A | 4 |
| Surfactant | SURFYNOL ® 440 | 0.3 |
| Water | Deionized water | Balance |

An example inkjet ink as disclosed herein was also prepared. The general formulation of example inkjet ink is shown in Table 4, with the wt % active of each component that was used (e.g., wt % active white pigment). A 5 wt % potassium hydroxide aqueous solution was added until a pH of about 8.5 was achieved.

TABLE 4
Inkjet Ink

| Ingredient | Specific Component | wt % active |
|---|---|---|
| Pigment dispersion | White pigment dispersion | 10 |
| Co-solvent | 2-methyl-1,3-propanediol | 9 |
| | DOWANOL ® TPM | 1 |
| Surfactant | SURFYNOL ® 440 | 0.3 |
| Binder | IMPRANIL ® DLN-SD | 8 |
| Anti-decel agent | LIPONIC ® EG-1 | 2 |
| Antimicrobial agent | ACTICIDE ® B20 | 0.04 |
| Water | Deionized water | Balance |

Example prints 1-4 were generated using the respective ex. pre-treated fabrics 1-4, the fixer composition, and the inkjet ink. For each example print, fixer composition (total of 55 gsm) and the inkjet ink (total of 300 gsm) were inkjet printed (using an 11 ng thermal inkjet printhead and wet on wet printing) over 6 passes on the ex. pre-treated fabrics 1-4. The example prints 1-4 were cured at 150° C. for 3 minutes.

Comp. print 5 was formed on comp. fabric 5, which did not have pre-treatment composition applied thereto and was not exposed to pre-heating. The fixer composition and inkjet ink were applied in the same manner as the example prints.

Comp. print 6 was formed on comp. fabric 6, was exposed to pre-heating, but did not have pre-treatment composition applied thereto prior to pre-heating. The fixer composition and inkjet ink were applied in the same manner as the example prints.

Comp. prints 7 and 8 were formed, respectively on comp. fabrics 7 and 8, which had water as a pre-treatment fluid. The fixer composition and inkjet ink were applied in the same manner as the example prints.

All of the comp. prints 5-8 were cured at 150° C. for 3 minutes.

Each example and comp. print was tested for washfastness. The initial L*a*b* values of the example and comp. prints were measured. The L*a*b* values of a color (e.g., white) before and after the 5 washes were measured. L* is lightness, a* is the color channel for color opponents green-red, and b* is the color channel for color opponents blue-yellow. Then, each example and comp. print was washed 5 times in a Whirlpool Washer (Model WTW5000DW) with warm water (at about 40° C.) and detergent. Each example and comp. print was allowed to air dry between each wash. Then, the L* a*b* values after the 5 washes of each example and comp. print were measured.

The color change ΔE was calculated by:

66 ECIE*=[(ΔL*)²+(Δa*)²(Δb*)²]^{0.5}

The results of the washfastness test for each example and comp. print are shown in Table 5.

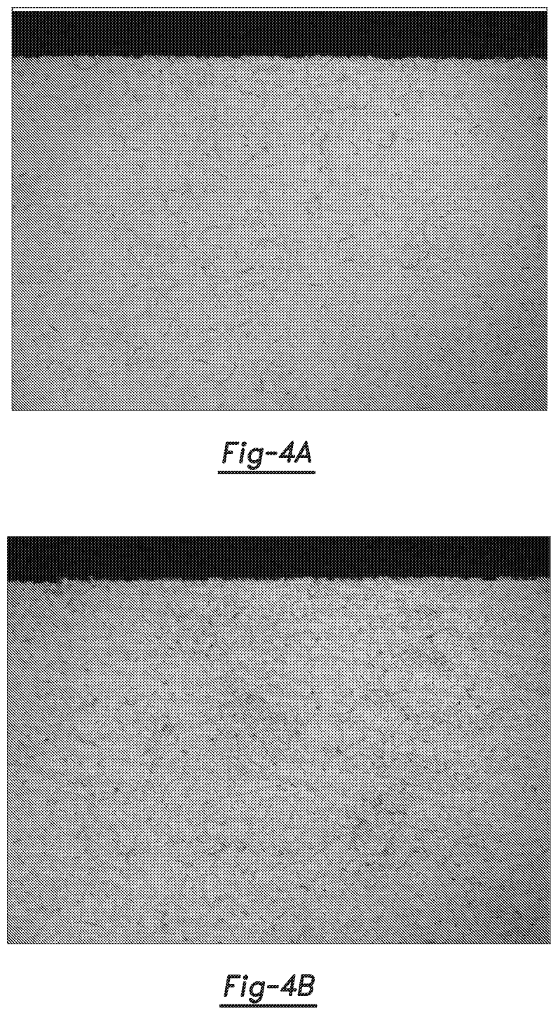

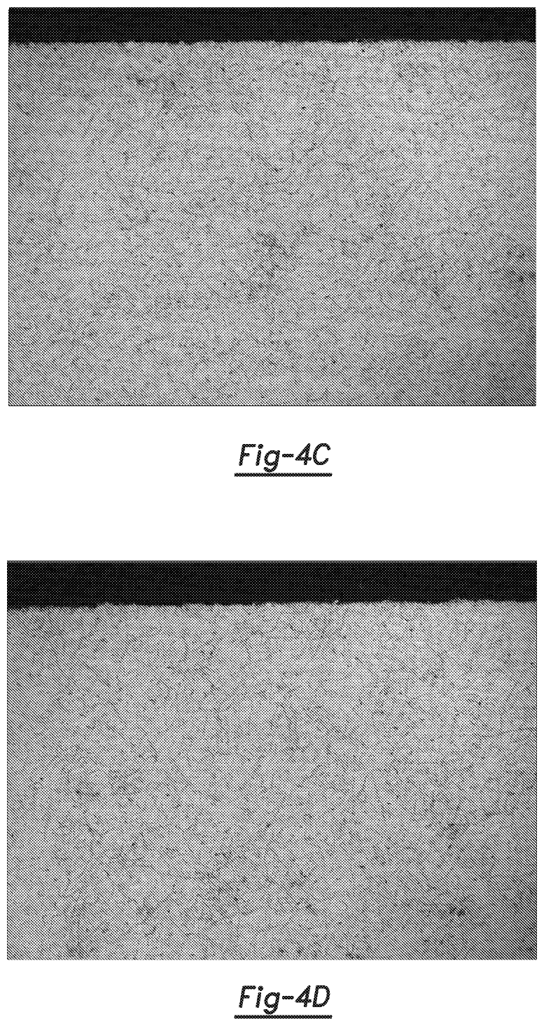

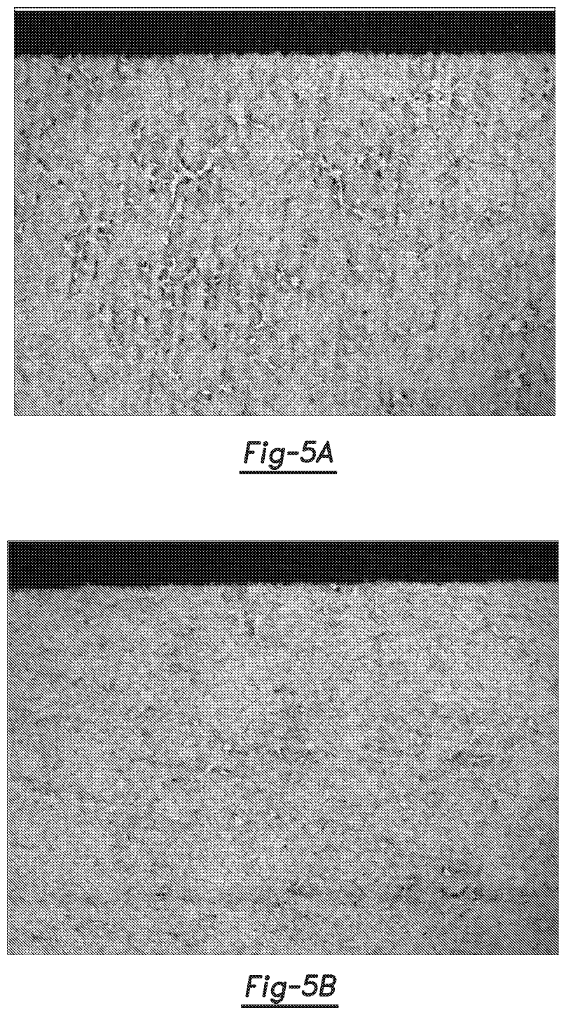

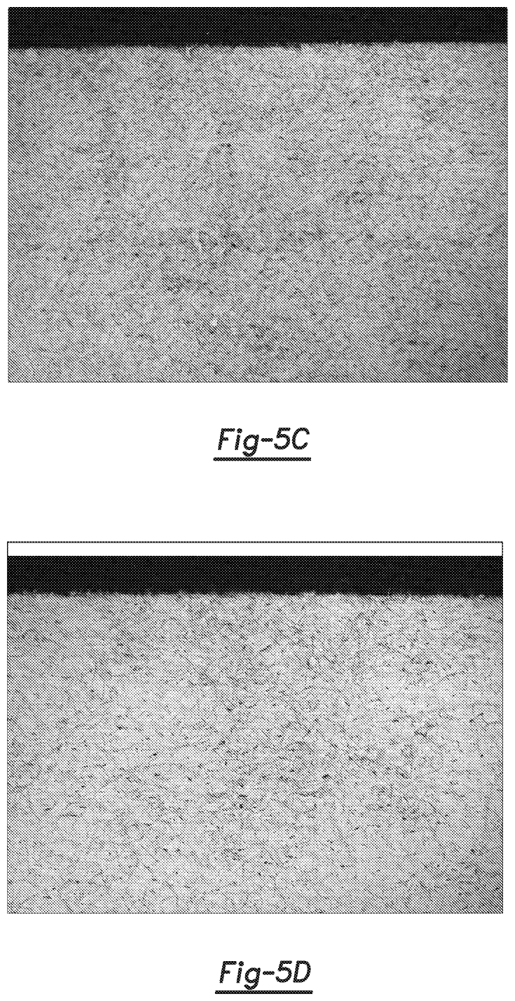

Optical microscope images were taken of the example and comp. prints. The images of the example prints 1 through 4 are respectively shown in FIG. 4A through FIG. 4D, and images of the comp. prints 5 through 8 are respectively shown in FIG. 5A through FIG. 5D. The quality of the images was visually assessed, and was designated poor (fibers sticking up, very non-uniform), marginal (more uniform than “poor”, but fibers still sticking up), good (uniform print surface, very few fibers sticking up), and very good (uniform print surface, no fibers sticking up). The image quality results are also presented in Table 5.

TABLE 5

| | Pre- | | L* | L* | | |
|---|---|---|---|---|---|---|
| | treatment | Pre- | before | after 5 | | Image |
| Print ID | (gsm) | Heating | wash | washes | ΔECIE | Quality |
| Ex. | PTC 1 | Heat press | 89.0 | 89.2 | 0.23 | Good |
| Print 1 | (70.0) | 150° C., | | | | |
| | | 1 min | | | | |
| Ex. | PTC 2 | Heat press | 86.4 | 85.8 | 0.65 | Very |
| Print 2 | (68.2) | 150° C., | | | | Good |
| | | 1 min | | | | |
| Ex. | PTC 3 | Heat press | 85.8 | 86.3 | 0.54 | Good |
| Print 3 | (59.6) | 150° C., | | | | |
| | | 1 min | | | | |
| Ex. | PTC 4 | Heat press | 85.2 | 85.7 | 0.58 | Good |
| Print 4 | (63.2) | 150° C., | | | | |
| | | 1 min | | | | |
| Comp. | No fluid | None | 74.3 | 74.5 | 0.37 | Poor |
| Print 5 | | | | | | |
| Comp. | No fluid | Heat press | 79.6 | 76.1 | 3.49 | Marginal |
| Print 6 | | 150° C., | | | | |
| | | 1 min | | | | |
| Comp. | Water | Heat press | 79.1 | 78.3 | 0.82 | Marginal |
| Print 7 | (75.6) | 150° C., | | | | |
| | | 1 min | | | | |
| Comp. | Water | None, | 86.6 | 86.0 | 1.59 | Good |
| Print 8 | (200) | squeegee | | | | |

Overall, the color change, ΔE, was less for the example prints compared to the comp. example prints, and the image quality of the example prints was better in terms of both print uniformity and reduced fibrillation than all of the comp. prints after washing.

The results for comp. prints 5 and 6 illustrated that white image quality suffered when no fluid was used to pre-treat the fabric. Specifically for comp. print 5 (formed on un-treated comp. fabric 5), the white pigment could not be fixed effectively on the fabric surface without any pre-treatment. As shown in Table 5, this led to low opacity (e.g. low L*) and poor image quality of the white print.

The results for comp. prints 7 and 8 illustrated that when water was used to pre-treat the fabric, a large amount of water was needed to achieve good image quality. Spraying 200 gsm water (comp. fabric 8) seems to fill the fabric pores, which slowed down white pigment penetration and helped improve opacity and image quality (e.g., when compared to comp. prints 5-7). However, the extra amount of water had to be removed in the curing step after the white ink was printed. Although all of the example and comparative example prints were cured for the same time, it is believed that the example prints could cure in a much shorter time frame (e.g., as low as 10 seconds). As such, water pre-treatment (which is more effective at higher amounts of water) may create an energy burden and reduced productivity because extra amount of energy and time may be needed for water removal.

The opacity and image quality of ex. prints 1-4 (including wax pre-treatment along with the fixer and ink) were similar to or better than comp. print 8 (including 200 gsm sprayed water as the pre-treatment). It is believed, however, that the energy consumption and the time needed in curing ex. prints 1-4 can be reduced compared with comp. print 8.

The results for example prints 1-4 illustrate that with the wax emulsion pre-treatment composition, the amount of fluid needed for pre-treatment was greatly reduced (compared to the amount of water used for comp. prints 7 and 8) without compromising on image quality. The results for example prints 1-4 also illustrated that the hydrophobicity of the textile fabric was increased, which slowed down ink penetration and lead to higher L* and better image quality.

### Example 2

Three examples of the pre-treatment composition disclosed herein were prepared with fluorinated polymer emulsions. To prepare the pre-treatment compositions, three different commercially available fluorinated polymer emulsions were diluted with deionized water to obtain fluids having 10 wt % active fluorinated polymer.

The surface tension, viscosity, pH, and average particle size (a volume-weighted mean diameter, Mᵥ (in microns) were measured for each pre-treatment composition. The surface tension was measured by the Wilhelmy plate method with a Kruss tensiometer. The viscosity was measured at room temperature (25° C.) using a Viscolite viscometer. The particle size was measured using a NANOTRAC® Wave device, from Microtrac.

The pre-treatment compositions and their associated properties are shown in Table 6.

TABLE 6
Pre-Treatment Compositions

| | | Surface | Vis- | | Particle |
|---|---|---|---|---|---|
| PTC | Fluorinated | Tension | cosity | | Size Mᵥ |
| ID | Polymer Emulsion | (dynes/cm) | (cp) | pH | (μm) |
| 9 | 10 wt % active | 27.32 | 1.0 | 3.33 | 0.2658 |
| | DYNEON ™ PTFE TF | | | | |
| | 5060GZ | | | | |
| 10 | 10 wt % active | 44.5 | 1.4 | 4.70 | 0.0895 |
| | X-CAPE ™ 2014 | | | | |
| 11 | 10 wt % active | 38.47 | 1.1 | 2.92 | 0.0727 |
| | PHOBOL ® CP-CR | | | | |

Gildan black midweight 780 cotton T-shirts (having a basis weight of 180 gsm) were used as the textile fabric in this example.

Example pre-treated fabrics 9-11 were generated using the respective pre-treatment compositions 9-11. For each example pre-treated fabric, the corresponding pre-treatment composition (60 gsm to 70 gsm) was first applied to a piece of the fabric using a spraying technique. The pre-treated fabrics were exposed to 150° C. and pressure of 3 atm when pressed in a clam shell hot press for 1 minute.

The pre-treated fabrics 9-11 were exposed to a water penetration test. During this test, the time it took for water to penetrate the pre-treated fabric or the comparative fabric was timed. A drop of water was put onto the pre-treated fabric using a pipette, and the time it took for the water to penetrate the fabric (i.e., completely soak into the fabric) was measured. These results are shown in Table 7. These results were compared with the results for comp. fabrics 5-8 from Example 1 (which are also reproduced in Table 7).

TABLE 7

| | Pre- | | | |
|---|---|---|---|---|
| | treatment | Pre- | Time for water to | |
| Fabric ID | (gsm) | Heating | penetrate fabric | |
| Ex. Pre-treated | PTC 9 | Heat press | 3.5 | sec |
| Fabric 9 | (65.0) | 150° C., | | |
| | | 1 min | | |
| Ex. Pre-treated | PTC 10 | Heat press | >15 | min |
| Fabric 10 | (62.0) | 150° C., | | |
| | | 1 min | | |
| Ex. Pre-treated | PTC 11 | Heat press | >15 | min |
| Fabric 11 | (62.9) | 150° C., | | |
| | | 1 min | | |
| Comp. Fabric 5 | No fluid | None | <1 | s |
| Comp. Fabric 6 | No fluid | Heat press | <1 | s |
| | | 150° C., | | |
| | | 1 min | | |
| Comp. Fabric 7 | Water | Heat press | <1 | s |
| | (75.6) | 150° C., | | |
| | | 1 min | | |
| Comp. Fabric 8 | Water | None, | <1 | s |
| | (200) | squeegee | | |

When the fabric was treated with <100 gsm of the perfluoroacrylated polymer pre-treatment compositions PTC 10 to PTC 11, the fabric surface became much more hydrophobic than the untreated, heat treated, and water treated comp. fabrics. When the fabric was treated with <100 gsm of the PTFE polymer pre-treatment composition PTC 9, the fabric surface became slightly more hydrophobic than the untreated, heat treated, and water treated comp. fabrics. As shown in Table 7 for ex. pre-treated fabrics 10 and 11, the hydrophobic surface greatly slowed down liquid penetration into the fabric. For each example perfluoroacrylated polymer pre-treated fabric, the drop of water stayed on the treated fabric surface for greater than 15 minutes.

Each of the pre-treated fabrics was then used to generate a print. The example fixer composition and the example inkjet ink from Example 1 were used in this example.

Example prints 9-11 were generated using the respective ex. pre-treated fabrics 9-11, the fixer composition, and the inkjet ink. For each example print, fixer composition (total of 55 gsm) and the inkjet ink (total of 300 gsm) were inkjet printed (using an 11 ng thermal inkjet printhead and wet on wet printing) over 6 passes on the ex. pre-treated fabrics 9-11. The example prints 9-11 were cured at 150° C. for 3 minutes.

Each example print was tested for washfastness as described in Example 1. The washfastness results are shown in Table 8. These results were compared with the results for comp. fabrics 5-8 from Example 1 (which are also reproduced in Table 8).

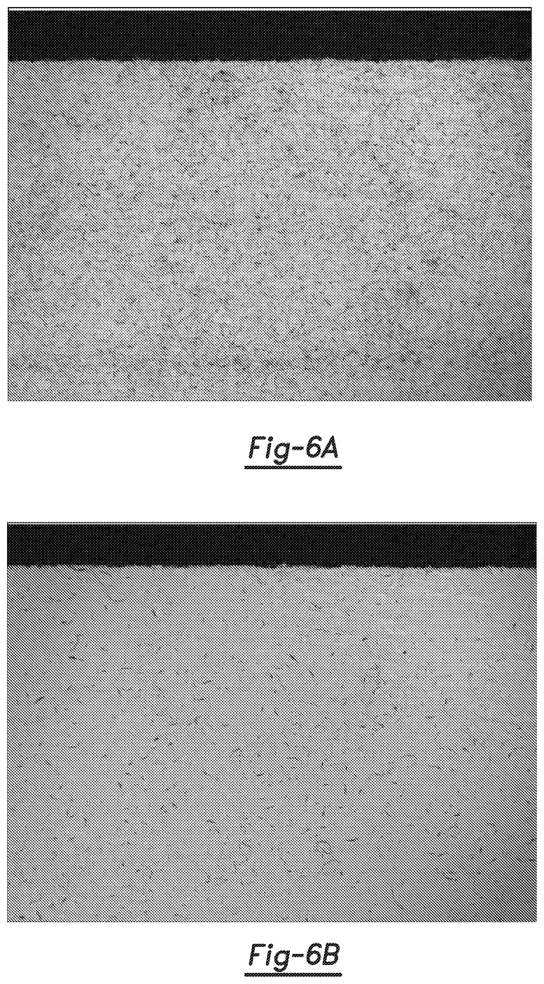

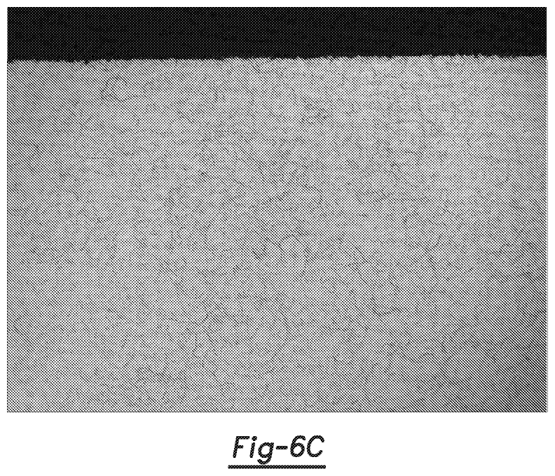

Optical microscope images were taken of the example prints. The images of the example prints 9 through 11 are respectively shown in FIG. 6A through FIG. 6C. The quality of the images was visually assessed as described in Example 1. The image quality results are also presented in Table 8. These results were compared with the results for comp. fabrics 5-8 from Example 1 (which are also reproduced in Table 8). As noted in Example 1, the optical microscope images of the comp. prints are shown in FIG. 5A through 5D.

The printed and cured white images (both example prints 9-11 and comp. prints 7 and 8 from Example 1) were also tested for oil penetration. Vegetable oil was dropped onto the example or comp. print, and the time it took for vegetable oil to penetrate the images was timed. The oil resistance results are also presented in Table 8.

TABLE 8

| | Pre- | | Time for veg. | | L* | L* | | |
|---|---|---|---|---|---|---|---|---|
| | treatment | Pre- | oil to penetrate | | before | after 5 | | Image |
| Print ID | (gsm) | Heating | white image | | wash | washes | ΔECIE | Quality |
| Ex. | PTC 9 | Heat press | 35 | sec | 85.8 | 85.5 | 0.41 | Good |
| Print 9 | (65.0) | 150° C., | | | | | | |
| | | 1 min | | | | | | |
| Ex. | PTC 10 | Heat press | >10 | min | 92.1 | 92.7 | 0.57 | Very |
| Print 10 | (62.0) | 150° C., | | | | | | Good |
| | | 1 min | | | | | | |
| Ex. | PTC 11 | Heat press | >10 | min | 90.3 | 91.0 | 0.95 | Very |
| Print 11 | (62.9) | 150° C., | | | | | | Good |
| | | 1 min | | | | | | |
| Comp. | No fluid | None | — | | 74.3 | 74.5 | 0.37 | Poor |
| Print 5 | | | | | | | | |
| Comp. | No fluid | Heat press | — | | 79.6 | 76.1 | 3.49 | Marginal |
| Print 6 | | 150° C., | | | | | | |
| | | 1 min | | | | | | |
| Comp. | Water | Heat press | 35 | sec | 79.1 | 78.3 | 0.82 | Marginal |
| Print 7 | (75.6) | 150° C., | | | | | | |
| | | 1 min | | | | | | |
| Comp. | Water | None, | 40 | sec | 86.6 | 86.0 | 1.59 | Good |
| Print 8 | (200) | squeegee | | | | | | |

The results for example print 9 illustrated that oil resistance and print performance (e.g., in terms of durability and image quality) was improved compared to when the fabric was left untreated or was pre-heated (without pre-treatment fluid).

The results for example prints 10 and 11 illustrated that the hydrophobicity of the textile fabric was increased when perfluoroacrylate polymers were used, which slowed down ink penetration and lead to higher L* and better image quality. The perfluoroacrylate polymer pre-treatment compositions (PTC 10 and PTC 11) produced prints (ex. prints 10 and 11) with better opacity and image quality than prints exposed to spraying with 200 gsm water (comp. print 8). Moreover, it is believed that both the energy consumption and the time needed to cure ex. prints 10 and 11 can be reduced compared with comp. print 8.

The results for example prints 10 and 11 also illustrated that oil resistance performance was also improved compared to comp. prints 7 and 8 that were pre-treated with water. With ex. prints 10 and 11, the oil droplet remained intact on the surface of the printed image for more than 10 minutes. These results indicate that the perfluoroacrylate polymers improve the fabric's resistance to oil stains. While comp. prints 5 and 6 were not tested for oil resistance it is expected that the untreated or heat treated prints would have poor oil resistance because the fabric is very hydrophilic. The results for example prints 10 and 11 were unexpected, in part because ex. print 9 (pre-treated with PTFE) did not exhibit much of an improvement in terms of oil resistance compared to the water treated comparative examples (comp. prints 7 and 8).

It is to be understood that the ranges provided herein include the stated range and any value or sub-range within the stated range, as if the value(s) or sub-range(s) within the stated range were explicitly recited. For example, a range from about 1 wt % to about 40 wt %, should be interpreted to include not only the explicitly recited limits of from about 1 wt % to about 40 wt %, but also to include individual values, such as about 5.15 wt %, about 32.25 wt %, about 35 wt %, about 25 wt %, etc., and sub-ranges, such as from about 2.5 wt % to about 30 wt %, from about 10 wt % to about 20 wt %, from about 5 wt % to about 35 wt %, etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A fluid set, comprising:
a pre-treatment composition, including:
a wax emulsion; or
a fluorinated polymer emulsion;
a fixer composition, including:
a cationic polymer; and
a fixer vehicle; and
an inkjet ink, including:
a white pigment;
a polymeric binder; and
an ink vehicle.

2. The fluid set as defined in claim 1 wherein the pre-treatment composition includes the wax emulsion, and the wax emulsion is selected from the group consisting of a paraffin wax emulsion, a polyethylene wax emulsion, an oxidized polyethylene wax emulsion, a carnauba wax emulsion, a beeswax emulsion, and a combination thereof.

3. The fluid set as defined in claim 1 wherein the pre-treatment composition includes the wax emulsion, and a wax in the wax emulsion has a glass transition temperature less than 150° C.

4. The fluid set as defined in claim 1 wherein the pre-treatment composition includes the wax emulsion, and the pre-treatment composition has a pH ranging from 2 to 10.

5. The fluid set as defined in claim 1 wherein the pre-treatment composition includes the fluorinated polymer emulsion, and a fluorinated polymer in the fluorinated polymer emulsion is a perfluoroacrylated polymer.

6. The fluid set as defined in claim 1 wherein the wax emulsion or the fluorinated polymer emulsion is an aqueous emulsion, and wherein the pre-treatment composition further includes a co-solvent, a surfactant, and additional water.

7. The fluid set as defined in claim 1 wherein the pre-treatment composition has a viscosity ranging from about 1 cP to about 100 cP at a temperature ranging from 20° C. to 25° C.

8. The fluid set as defined in claim 1 wherein the cationic polymer of the fixer composition is selected from the group consisting of poly(diallyldimethylammonium chloride); poly(methylene-co-guanidine) anion, wherein the anion is selected from the group consisting of hydrochloride, bromide, nitrate, sulfate, and sulfonates; a polyamine; poly(dimethylamine-co-epichlorohydrin); a polyethylenimine; a polyimide epichlorohydrin resin; a polyamine epichlorohydrin resin; and a combination thereof.

9. The fluid set as defined in claim 1 wherein:
the pre-treatment composition includes the wax emulsion, and the wax emulsion is present in an amount ranging from about 1 wt % to about 40 wt % based on a total weight of the pre-treatment composition; or
the pre-treatment composition includes the fluorinated polymer emulsion, and the fluorinated polymer emulsion is present in an amount ranging from about 0.5 wt % to about 20 wt % based on a total weight of the pre-treatment composition.

10. A textile printing kit, comprising:
a textile fabric selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof;
a pre-treatment composition, including:
a wax emulsion; or
a fluorinated polymer emulsion;
a fixer composition, including:
a cationic polymer; and
a fixer vehicle; and
an inkjet ink, including:
a white pigment;
a polymeric binder; and
an ink vehicle.

11. A printing method, comprising:
generating a print by:
applying a pre-treatment composition on a textile fabric to form a pre-treatment composition layer, the pre-treatment composition including:
a wax emulsion; or
a fluorinated polymer emulsion;
applying heat and pressure to the pre-treatment composition layer on the textile fabric to form a pre-treatment film;
inkjet printing a fixer composition on the pre-treatment film to form a fixer layer, the fixer composition including:
a cationic polymer; and
a fixer vehicle; and
inkjet printing an inkjet ink on the fixer layer to form an ink layer, the inkjet ink including:
a white pigment;
a polymeric binder; and
an ink vehicle; and
thermally curing the print.

12. The printing method as defined in claim 11 wherein the pre-treatment composition is applied in an amount less than 100 gsm.

13. The printing method as defined in claim 11 wherein the heat applied to the pre-treatment composition layer on the textile fabric ranges from about 80° C. to about 200° C.

14. The printing method as defined in claim 11 wherein the pressure applied to the pre-treatment composition layer on the textile fabric ranges from about 0.1 atm to about 8 atm.

15. The printing method as defined in claim 11 wherein the heat and the pressure are applied to pre-treatment composition layer on the textile fabric for a period of time ranging from about 10 seconds to about 30 minutes.
